(19) United States
(12) Patent Application Publication
(10) Pub. No.: US 2013/0294299 A1
(43) Pub. Date: Nov. 7, 2013

(54) METHOD AND APPARATUS FOR PROCESSING A HARQ ACK/NACK SIGNAL

(71) Applicants: Dong Hyun Park, Seoul (KR); Chang Kyu Yoob, Seoul (KR); Sung Kwon Hong, Seoul (KR)

(72) Inventors: Dong Hyun Park, Seoul (KR); Chang Kyu Yoob, Seoul (KR); Sung Kwon Hong, Seoul (KR)

(73) Assignee: Pantech Co., Tld, Seoul (KR)

(21) Appl. No.: 13/980,833

(22) PCT Filed: Jan. 18, 2012
(86) PCT No.: PCT/KR2012/000420

§ 371 Date: Jul. 19, 2013

(30) Foreign Application Priority Data
Jan. 21, 2011 (KR) 1020110006435
Jan. 31, 2011 (KR) 1020110009727

(51) Int. Cl. H04W 72/04

(52) U.S. Cl. CPC H04W 72/0406
USPC 370/280; 370/328

(57) ABSTRACT

The present invention relates to a method and apparatus for processing a HARQ ACK/NACK signal. The method for processing a HARQ ACK/NACK signal according to the present invention comprises the following steps: bundling predetermined HARQ ACK/NACK signals from among a plurality of HARQ ACK/NACK signals; ordering transmission-object HARQ ACK/NACK signal including the bundled HARQ ACK/NACK signals; segmenting the ordered transmission-object HARQ ACK/NACK signals; and channel-coding the segmented transmission object HARQ ACK/NACK signals according to the ordered sequence. The method for processing a HARQ ACK/NACK signals according to the present invention may be performed in a terminal which transmits a HARQ ACK/NACK signal through a PUCCH format 3 in a TDD (Time Division Duplex) environment.

### CROSS-REFERENCE TO RELATED APPLICATIONS

This Application is the National Stage Entry of International Application No. PCT/KR2012/000420, filed on Jan. 18, 2012, and claims priority to and the benefit of Korean Application Nos. 10-2011-0006435, filed on Jan. 21, 2011, and 10-2011-0009727, filed on Jan. 31, 2011, all of which are hereby incorporated by reference as if fully set forth herein.

### BACKGROUND

1. Field

The present invention relates to wireless communication and, more particularly, to a method for configuring and transmitting an HARQ (Hybrid ARQ) ACK/NACK signal, and a device using the same in a wireless communication system supporting multiple carriers.

2. Discussion of the Background

In general, a wireless communication system uses a single bandwidth to transmit data. For example, a 2^{nd}-generation wireless communication system uses a bandwidth ranging from 200 KHz to 1.25 MHz, and 3^{rd}-generation wireless communication system uses a bandwidth ranging from 5 MHz to 10 MHz. In order to support increasing transmission capacity, recently, LTE (Long Term Evolution) or IEEE 802.16m of 3GPP (3rd Generation Partnership Project) extends the bandwidth to 20 MHz or higher. To increase transmission capacity, increasing the bandwidth may be essential, but it is not easy to assign a frequency having a high bandwidth, except for some areas in the world.

A carrier aggregation (CA) technology aiming at obtaining an effect, as if a logically high band is used, by grouping a plurality of physically non-continuous bands in a frequency domain has been developed to effectively use fragmented small bands. Individual unit carriers grouped by carrier aggregation is known as a component carrier (CC). Each CC is defined by a single bandwidth and a center frequency.

A system in which data is transmitted and/or received in a broadband through a plurality of CCs is referred to as a multi-component carrier system (multi-CC system) or a carrier aggregation (CA) environment. The multi-component carrier system performs both a narrow band and a broad band by using one or more carriers. For example, when a single carrier corresponds to a bandwidth of 5 MHz, a bandwidth of a maximum of 20 MHz may be supported by using four carriers.

In order to operate the multi-CC system, various control signals are required is between a base station (BS) and a user equipment (UE). For example, exchanging ACK (ACKnowledgement)/NACK (Not-ACKnowledgement) information for performing HARQ (Hybrid Automatic Repeat reQuest), exchanging CQI (Channel Quality Indicator) indicating downlink channel quality, and the like, are required.

### SUMMARY

An aspect of the present invention provides a method for performing bundling on HARQ ACK/NACK signals by using a PUCCH format 3 in a case in which the HARQ ACK/NACK signals exceed 20 bits, thereby effectively performing channel coding in consideration thereof.

(1) According to an aspect of the present invention, there is provided: a method for processing HARQ ACK/NACK signals of a user equipment (UE) that transmits HARQ ACK/NACK (Hybrid Automatic Repeat request ACKnowledge/Non-ACK) signals through a PUCCH format 3 in a TDD (Time Division Duplex) environment, including:

bundling predetermined HARQ ACK/NACK signals among HARQ ACK/NACK signals; ordering HARQ ACK/NACK signals including the bundled HARQ ACK/NACK signals; segmenting the ordered HARQ ACK/NACK signals; and performing channel-coding on the segmented HARQ ACK/NACK signals according to the ordered sequence, wherein the channel coding is performed by dual-coders, and the segmented HARQ ACK/NACK signals are divided to be input to the dual-coders, respectively.

(2) In (1), in the ordering, the bundled HARQ ACK/NACK signals may be ordered such that they are evenly distributed to the dual-coders, respectively.

(3) In (2), in the ordering, the bundled HARQ ACK/NACK signals may be ordered such that they are first distributed to the dual-coders before unbundled HARQ ACK/NACK signals.

(4) In (2), in the ordering, the bundled HARQ ACK/NACK signals may be evenly distributed to each of the dual-coders sequentially one by one.

(5) In (2), in the ordering, unbundled HARQ ACK/NACK signals may be interleaved and ordered.

(6) In (1), in the bundling, HARQ ACK/NACK signals with respect to deactivated component carriers (CCs) may be first bundled.

(7) In (6), the bundling may be performed until when the number of bits of the HARQ ACK/NACK signals reaches a predetermined number of bits, and in a case in which the number of bits of the HARQ ACK/NACK signals is greater than the predetermined number of bits even after the HARQ ACK/NACK signals with respect to the deactivated CCs are bundled, HARQ ACK/NACK signals with respect to a primary component carrier (PCC) or HARQ ACK/NACK signals with respect to a CC having a larger number of subframes that transmit a plurality of codewords among activated CCs may be first bundled.

(8) In (6), in the ordering, after HARQ ACK/NACK signals segmented to be input to any one of the dual-coders are completely distributed, HARQ ACK/NACK signals to be segmented and input to the other coder may be distributed, and the segments of the bundled HARQ ACK/NACK signals may be first distributed to one coder.

(9) In (8), in the ordering, among the segments of the bundled HARQ ACK/NACK signals, segments with respect to the deactivated CC may be first distributed.

(10) In (6), in the ordering, the segments of the bundled HARQ ACK/NACK signals may be evenly distributed to each coder constituting the dual-Reed Muller coders.

(11) According to another aspect of the present invention, there is provided a user equipment (UE) transmitting an HARQ ACK/NACK (Hybrid Automatic Repeat request ACKnowledge/Non-ACK) signal, including:

a bundling unit configured to bundle HARQ ACK/NACK signals; an ordering unit configured to order HARQ ACK/NACK signals including the bundled HARQ ACK/NACK signals;

a segmentation unit configured to segment the ordered HARQ ACK/NACK signals; and a coding unit configured to perform channel coding the segmented HARQ ACK/NACK signals according to the ordered sequence, wherein the coding unit includes dual-coders, the segmentation unit divides and inputs the segmented HARQ ACK/NACK signals the dual-coders, and the bundling unit may perform bundling until when the number of the HARQ ACK/NACK signals reaches a predetermined number of bits.

(12) In (11), the bundling unit may perform bundling, starting from HARQ ACK/NACK signals with respect to deactivated component carriers (CCs).

(13) In (11), the ordering unit may distribute the segments of the bundled HARQ ACK/NACK signals such that they are concentratively input to one coder constituting the dual-Reed Muller coders or may evenly distribute the segments of the bundled HARQ ACK/NACK signals to the two coders constituting the dual-Reed Muller coders.

(14) According to another aspect of the present invention, there is provided: a method for processing an HARQ ACK/NACK (Hybrid Automatic Repeat request ACKnowledge/Non-ACK)signal of a base station (BS), including:

Determining a method for configuring and/or transmitting HARQ ACK/NACK signals; transmitting information regarding the determined method for configuring and/or transmitting HARQ ACK/NACK signals to a user equipment (UE); performing downlink data transmission; and receiving HARQ ACK/NACK signals with respect to the downlink data transmission from the UE, wherein the information regarding the method for configuring and/or transmitting HARQ ACK/NACK signals includes at least any one of a payload size of the HARQ ACK/NACK signals to be transmitted by the UE, a bundling method to be performed by the UE, and an ordering method to performed by the UE, and the HARQ ACK/NACK signals transmitted from the UE are configured and/or transmitted on the basis of the information regarding the method for configuring and/or transmitting HARQ ACK/NACK signals.

(15) In (14), in the determining, the UE may determine whether to perform bundling starting from HARQ ACK/NACK signals with respect to deactivated component carriers (CCs).

(16) In (14), in the determining, the UE may determine to distribute the segments of the bundled HARQ ACK/NACK signals such that they are concentratively input to one coder constituting the dual-Reed Muller coders, or determine to distribute evenly the segments of the bundled HARQ ACK/NACK signals to the two coders constituting the dual-coders. (17) According to another aspect of the present invention, there is provided a base station (BS) device receiving HARQ ACK/NACK signals through a PUCCH format 3 in a TDD (Time Division Duplex) environment, including: a controller configured to determine a method for configuring and/or transmitting HARQ ACK/NACK signals; and an RF (Radio Frequency) unit configured to transmit information regarding the determined method for configuring and/or transmitting HARQ ACK/NACK signals to a user equipment (UE), and receive HARQ ACK/NACK signals with respect to downlink data transmission from the UE, wherein

the method for configuring and/or transmitting HARQ ACK/NACK signals includes at least any one of a payload size of the HARQ ACK/NACK signals to be transmitted by the UE, a bundling method to be performed by the UE, and an ordering method to performed by the UE, and the HARQ ACK/NACK signals transmitted from the UE are configured and/or transmitted on the basis of the information regarding the method for configuring and/or transmitting HARQ ACK/NACK signals.

According to embodiments of the present invention, in case of transmitting HARQ ACK/NACK signals exceeding 20 bits by using a PUCCH format 3, bundling is performed thereon, and effective channel coding can be performed in consideration of it.

According to embodiments of the present invention, in case of transmitting HARQ ACK/NACK signals exceeding 20 bits by using a PUCCH format 3, HARQ signals with respect to activated component carriers (CCs) can be multiplexed to its maximum level and transmitted.

According to embodiments of the present invention, in case of transmitting HARQ ACK/NACK signals exceeding 20 bits by using a PUCCH format 3, channel coding can be effectively performed on HARQ signals.

### BRIEF DESCRIPTION OF THE DRAWINGS

FIG. 1 is view schematically illustrating an embodiment regarding a configuration of a user equipment to which the present invention is applied.

FIG. 2 is a view schematically illustrating another embodiment regarding a configuration of a UE to which the present invention is applied.

FIG. 3 is a flow chart illustrating an operation between a base station (BS) and a UE in a system to which the present invention is applied.

FIG. 4 is a flow chart schematically illustrating performing RM coding on HARQ ACK/NACK signals after going through bundling/ordering/segmentation in the UE of the system in order to transmit the signal.

FIGS. 5 through 9 are views schematically illustrating bundling and ordering performed on HARQ ACK/NACK signals in the system to which the present invention is applied.

FIG. 10 is a flow chart illustrating an operation performed by a BS in a case in which a UE bundles HARQ ACK/NACK signals having 20 or more bits through a PUCCH format 3 and transmits the same in the TDD system.

FIG. 11 is a view illustrating HARQ ACK/NACK signals with respect to component carriers (CCs) in respective subframes in a case in which all the CCs are activated.

FIGS. 12 through 36 are views schematically illustrating bundling and ordering performed on HARQ ACK/NACK signals in the system to which the present invention is applied.

FIG. 37 is a block diagram illustrating an example of configurations of a BS and a UE in the system to which the present invention is applied.

### DETAILED DESCRIPTION OF THE ILLUSTRATED EMBODIMENTS

Hereinafter, in the present disclosure, some embodiments will be described in detail with reference to the accompanying drawings.

A wireless communication system to which the present invention is applied may have a network structure of 3GPP LTE/LTE-A.

A user equipment (UE) may be referred to by other names such as user equipment (UE), mobile terminal (MT), user terminal (UT), subscriber station (SS), wireless device, personal digital assistant (PDA), wireless modem, handheld device, etc. A base station (BS) generally refers to a fixed station that communicates with a UE and may be referred to by other names such as evolved-node B (eNB), base transceiver system (BTS), access point (AP), etc.

A multi-access scheme applied to the wireless communication system according to an embodiment of the present invention is not limited.

Carrier aggregation (CA) supports a plurality of carriers, which is also called spectrum aggregation or bandwidth aggregation. Hereinafter, a multi-carrier system refers to a system supporting carrier aggregation.

Component carriers may be divided into a primary component carrier (PCC) and a secondary component carrier (SCC) depending on whether or not they are activated. A PCC is a carrier which is constantly activated, and an SCC is a carrier which is activated or deactivated according to particular conditions. Here, activation refers to a state in which traffic data is transmitted or received or a state in which traffic data is ready to be transmitted or received. Deactivation refers to a state in which traffic data cannot be transmitted or received and measurement or transmission or reception of minimum information is available. The UE may use only one primary component carrier or one or more secondary component carriers along with a primary component carrier. The UE may be allocated a primary component carrier and/or a secondary component carrier from the BS.

In carrier aggregation, a PDCCH may transmit information regarding allocation of resource of a different carrier, as well as allocation of resource within a carrier to which the pertinent PDCCH corresponds. This is known as cross-carrier scheduling.

When a UE receives downlink data (DL data) from a BS, it transmits an ACK (Acknowledgement)/NACK (Not-Acknowledgement) signal after the lapse of a certain period of time. In this disclosure, an ‘HARQ ACK/NACK signal’ includes an ACK signal, a NACK signal, and a DTX signal. In a carrier aggregation (CA) environment, HARQ ACK/NACK signals with respect to a plurality of downlink component carriers may be transmitted via a single uplink component carrier.

Here, a PUCCH (Physical Uplink Control Channel) transmitting an HARQ ACK/NACK signal may support multiple formats. Namely, it can transmit uplink control information having different number of bits per subframe according to a modulation scheme. An ACK/NACK signal having 2 to 4 bits may be transmitted by using PUCCH format 1b with channel selection among the PUCCH formats. In channel selection, HARQ ACK/NACK resource is allocated with respect to downlink by using a table mapping a message to be transmitted and resource and modulation symbols to be used for transmission of the corresponding message. A channel selection table may be made up of combinations of a plurality of resource indices and modulation symbols of ACK/NACK signals and may be configured in consideration of the number (M) of bits used to transmit an ACK/NACK signal. Through channel selection, resource required for transmission of a signal having a maximum of 4 bits, so in case of an ACK/NACK signal having bits smaller than 4 bits, a table is configured according to values of number (M) of bits required for transmission of the ACK/NACK signal and ACK/NACK resource may be allocated by using the table.

Also, an HARQ ACK/NACK signal may be transmitted by using PUCCH format 3. The PUCCH format 3, a PUCCH format employing DFT-S-OFDM (Discrete Fourier Transform-Spreading-Orthogonal Frequency-Division Multiplexing), uses DFT-IFFT and block spreading. In case of transmitting an HARQ ACK/NACK signal by using the PUCCH format 3, information having a maximum of 10 bits in case of FDD and information having a maximum of 20 bits in case of TDD may be transmitted by an HARQ ACK/NACK signal. In addition, ACK/NACK information may be transmitted together with SR (Service Request) information. In this case, ACK/NACK information and the SR information may be transmitted by up to a maximum of 11 bits in case of FDD and a maximum of 21 bits in case of TDD by using one PUCH format 3 resource.

In order to transmit an ACK/NACK signal, a BS may implicitly allocate an ACK/NACK resource index. Implicitly allocating an ACK/NACK resource index by a BS means that the BS allocates a resource index calculated by using n_{CCE} indicating a number of a CCD among at least one CCD constituting a PDCCH of CC#a, as a parameter. The BS may also explicitly allocate a resource index. Explicitly allocating a resource index by a BS means that the BS allocates a resource index of a PUCCH dedicated to a specific UE to the UE through signaling such as a resource allocation indicator, or the like, without being dependent upon n_{CCE}.

A UE may transmit an ACK/NACK signal by using the allocated ACK/NACK resource (index).

In case of FDD (Frequency Division Duplex) mode, a UE transmits HARQ ACK/NACK signals with respect to PDSCH(s), which have been received in a subframe n-4, in a subframe n.

In the TDD (Time Division Duplex) mode, the UE performs uplink and downlink transmission through predetermined downlink/uplink frame setting. Through downlink/uplink setting, transmission resource may be allocated asymmetrically for uplink transmission and downlink transmission.

In case of TDD, the UE transmits HARQ ACK/NACKA signals with respect to PDSCH(s), which have been received in subframe(s) n-k, in an uplink subframe n. In this case, k is an element of K, and k may be defined by Table 1. K may be determined by an uplink-downlink (UL-DL) configuration and a subframe n and may include M number of elements {k₀, k₁, . . . , k_{M-1}}.

TABLE 1

| UL-DL | | | | | | | | | | |
|---|---|---|---|---|---|---|---|---|---|---|
| Configu- | Subframe n | | | | | | | | | |
| ration | 0 | 1 | 2 | 3 | 4 | 5 | 6 | 7 | 8 | 9 |
| 0 | — | — | 6 | — | 4 | — | — | 6 | — | 4 |
| 1 | — | — | 7, 6 | 4 | — | — | — | 7, 6 | 4 | — |
| 2 | — | — | 8, 7, | — | — | — | — | 8, 7, | — | — |
| | | | 4, 6 | | | | | 4, 6 | | |
| 3 | — | — | 7, 6, 11 | 6, 5 | 5, 4 | — | — | — | — | — |
| 4 | — | — | 12, 8, | 6, 5, | — | — | — | — | — | — |
| | | | 7, 11 | 4, 7 | | | | | | |
| 5 | — | — | 13, 12, 9, | — | — | — | — | — | — | — |
| | | | 8, 7, 5, | | | | | | | |
| | | | 4, 11, 6 | | | | | | | |
| 6 | — | — | 7 | 7 | 5 | — | — | 7 | 7 | — |

In Table 1, subframes including numbers are those performing uplink transmission.

Referring to Table 1, relationships between uplink subframes and downlink subframes can be checked. An HARQ ACK/NACK signal with respect to a downlink subframe may be transmitted through an uplink subframe with which the downlink subframe is associated.

Meanwhile, in downlink transmission, one codeword (CW) or two CWs may be transmitted in one element component (CC) in each frame. With respect to one CW, an 1-bit ACK/NACK signal is transmitted, and in case of PUCCH format 1b used for transmission of an ACK/NACK signal, an ACK/NACK signal having a maximum of 4 bits may be transmitted through channel selection. However, in case of the presence of a CC transmitting data by two codewords (CWs) per subframe via downlink, it may be difficult to transmit an ACK/NACK signal through PUCCH format 1a/1b. Thus, in this case, HARQ ACK/NACK signals having a payload size of up to 20 bits may be multiplexed and transmitted by using PUCCH format 3.

In a TDD system of a component aggregation (CA) environment, when each CC of downlink transmits data by 2CWs, a size of payload for transmission of HARQ ACK/NACK signals exceeds 20 bits in many cases. Also, even in a case in which only some of CCs of downlink transmits 2CWs, a size of payload of HARQ ACK/NACK signals may exceed 20 bits. Thus, in this case, although ACK/NACK signals are transmitted through PUCCH format 3, it is difficult to multiple and transmit the entire signals.

When a size of HARQ ACK/NACK signals to be transmitted exceeds a payload size, the ACK/NACK signals may be transmitted through spatial bundling. For example, ACK/NACK signals to be bundled with respect to downlink CCs or downlink subframes may be bundled through logical product operation (or an AND operation). Namely, in a case in which pieces of HARQ ACK/NACK information to b bundled with respect to downlink CCS or downlink subframes are all ACKs, ACK may be transmitted as an HARQ ACK/NACK signal representing the bundled ACK/NACK signals. In a case in which pieces of HARQ ACK/NACK information with respect to at least one CC or subframe is NACK, NACK may be transmitted as an HARQ ACK/NACK signal representing the bundled ACK/NACK signals. Also, in a case in which pieces of HARQ ACK/NACK information with respect to at least one CC or subframe is DTX, an HARQ ACK/NACK signal representing the bundled ACK/NACK signals may be DTX.

A BS may check the representative value of the bundled ACK/NACK signals and determine whether to retransmit corresponding data. For example, in a case in which bundled ACK/NACK signal values are ACK, the BS may determine that a UE has received all the corresponding signals and has successfully decoded them, and may not perform retransmission. When bundled ACK/NACK signal values are NACK or DTX, the BS may all the retransmit corresponding data.

Even in HARQ ACK/NACK signal transmission using the PUCCH format 3, in a case in which a payload size of HARQ ACK/NACK signals to be transmitted exceeds 20 bits, HARQ ACK/NACK signals may be transmitted by using spatial bundling. Targets of spatial bundling are HARQ ACK/NACK signals with respect to each of a plurality of CCs transmitted in a single CC in a downlink subframe. Thus, in case of spatial bundling, HARQ ACK/NACK signals with respect to each of transmitted 2CW may be bundled to a single representative signal with respect to a CC transmitting 2CW in one downlink subframe. Hereinafter, ‘spatial bundling’ will be described as ‘bundling’ for the description purpose, unless otherwise mentioned in the present embodiment. Meanwhile, although a CC can transmit 2CW, if it is scheduled to transmit only 1CW in a corresponding subframe, HARQ ACK/NACK signals may not be subjected to bundling.

Hereinafter, a case of bundling HARQ ACK/NACK signals having a payload size exceeding 20 bits and transmitting the same in a TDD environment will be described.

A UE may bundle HARQ ACK/NACK signals with respect to CWs transmitted in each CC of a downlink subframe. Thus, in a case in which one CC of a downlink subframe transmits one CW, HARQ ACK/NACK signals are not bundled, and in a case in which one CC of a downlink subframe transmits two CWs, HARQ ACK/NACK signals with respect to each CW are bundled and transmitted as a 1-bit HARQ ACK/NACK signal.

A bundling method may be previously determined between a UE and a BS or may be transferred to a UE through higher layer signaling. When HARQ ACK/NACK signals are transmitted through the PUCCH format 3, if the HARQ ACK/NACK signals have a payload size exceeding 11 bits, dual-RM (Reed-Muller) coding may be used as a channel coding method.

An RM code is a type of a linear error correction code used in communication, having orthogonality. An RM code is denoted by RM(r,d) in which r is order of a code and d is a length (2^{d}) of a codeword. RM(0,d) is a repetition code, and RM(d-1,d) is a parity check code.

Bundling HARQ ACK/NACK signals having bits equal to or greater than 20 bits and transmitting the same through the PUCCH format 3 in a case in which dual-RM coding is applied in a TDD environment will be described.

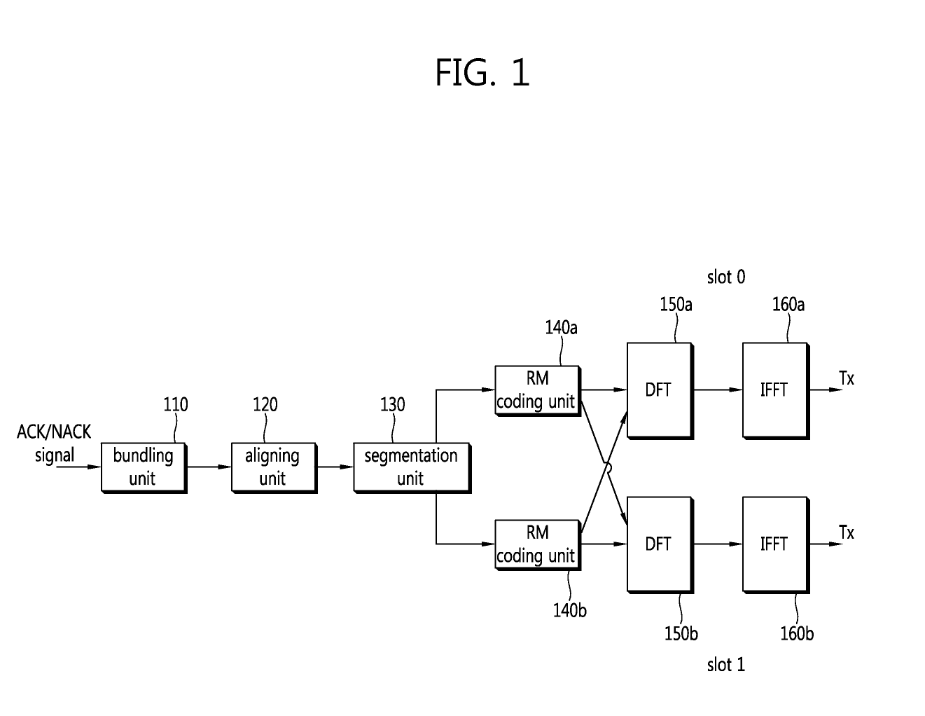

FIG. 1 is view schematically illustrating an embodiment regarding a configuration of a user equipment to which the present invention is applied.

A UE configures HARQ ACK/NACK signals with respect to a received PDSCH signal. In a case in which the HARQ ACK/NACK signals to be transmitted exceeds 20 bits, the HARQ ACK/NACK signals (bits) are input to a bundling unit 110. CCs transmitted in a downlink subframe may transmit 1CW or 2CW. A bundling unit 110 bundles HARQ ACK/NACK signals with respect to CCs transmitting 2CW. HARQ ACK/NACK signals with respect to which CC of which downlink subframe are to be bundled may be determined in advance between the UE and a BS or may be transmitted to the UE through higher layer signaling.

The bundled HARQ ACK/NACK signals are delivered to an ordering unit 120. The ordering unit 120 orders the input HARQ ACK/NACK signals such that the bundled HARQ ACK/NACK signals may be evenly input to RM coding units, respectively, as described hereinafter. To which of two RM coding units 140a and 140b the ordered HARQ ACK/NACK signals are to be input is determined. Here, the ordering unit 120 may order the HARQ ACK/NACK signals in consideration of the fact that the HARQ ACK/NACK signals are interleaved when input to the RM coding units 140a and 140b.

The HARQ ACK/NACK signals ordered in the ordering unit 120 are input to a segmentation unit 130.

The segmentation unit 130 segments the input HARQ ACK/NACK signals and input the same to the RM coding units 140a and 140b. The segmentation unit 130 inputs the HARQ ACK/NACK signals to be input to the first RM coding unit 140a, to the first RM coding unit 140a, and inputs HARQ ACK/NACK signals to be input to the second RM coding unit 140b, to the second RM coding unit 140b, according to the ordered sequence. As described above, dual-RM coding may support channel coding of HARQ ACK/NACK signal having a payload size exceeding 11 bits.

The RM coding units 140a and 140b perform channel coding through RM coding. Each of the RM coding units 140a and 140b may be able to process up to 11 bits at a time. Thus, the ordering unit 120 orders blocks of the HARQ ACK/NACK signals to be input to each of the RM coding units such that they are equal to or smaller than 11 bits. The ordering unit 120 may order a payload size (N) of HARQ ACK/NACK signals such that it is equally segmented into two HARQ ACK/NACK blocks. Here, a ceil function is a function outputting a minimum value among integers greater than or equal to the corresponding value (N2, here).

The blocks of the HARQ ACK/NACK signals input to the respective RM coding units 140a and 140b are modulated into 12 QPSK symbols, interleaved, and input to DFT (Discrete Fourier Transformation) units 150a and 150b in a cross manner, respectively. The DFT-processed signals are IFFT-processed in IFFT (Inverse Fast Fourier Transformation) units 160a and 160b and transmitted on two slots.

Here, the modulation scheme, the channel coding scheme, and the like, are is described for the description purpose, but the present invention is not limited thereto and may be applied to various other modulating schemes and channel coding schemes. Also, it should be appreciated that the UE of the system to which the present invention is applied may include a configuration for processing an additional process to process HARQ ACK/NACK signals as necessary, in addition to the foregoing configuration.

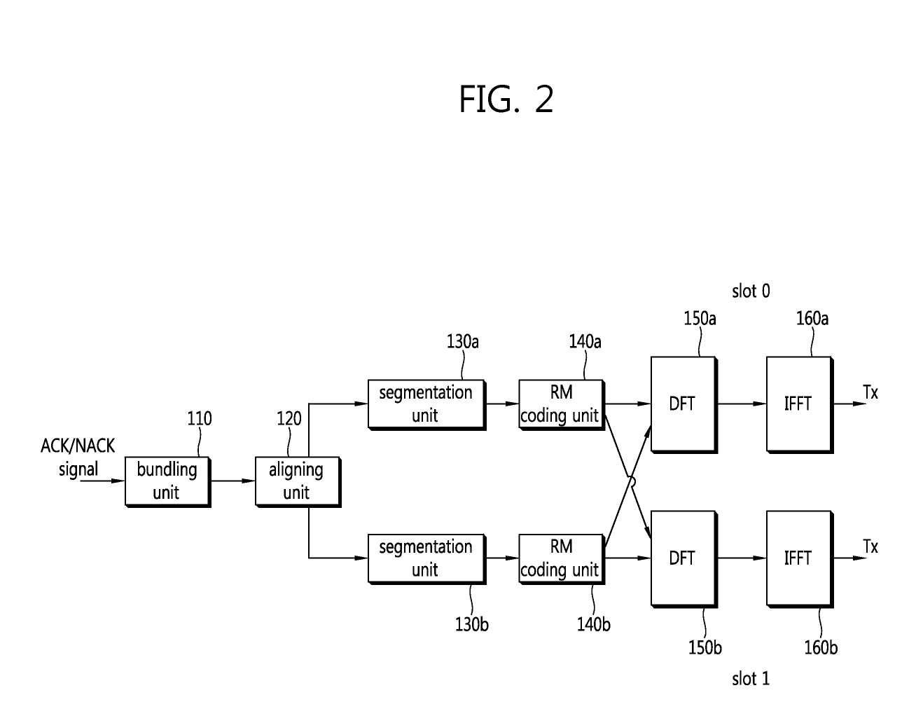

FIG. 2 is a view schematically illustrating another embodiment regarding a configuration of a UE to which the present invention is applied.

In comparison to the embodiment of FIG. 1, an embodiment of FIG. 2 includes a plurality of segmentation units 130a and 130b. In this case, the respective segmentation units 130a and 130b may perform processing of receiving HARQ ACK/NACK signals input to the respective RM coding units 140a and 140b from the ordering unit 120 and inputting the same to the respective RM coding units 140a and 140b in parallel. The first segmentation unit 130a receives HARQ ACK/NACK signals to be input to the first RM coding unit 140a from the ordering unit 120, segments them, and inputs the segmented HARQ ACK/NACK signals to the first RM coding unit 140a. Also, the second segmentation unit 130b receives HARQ ACK/NACK signals to be input to the second RM coding unit 140b from the ordering unit 120, segments them, and inputs the segmented HARQ ACK/NACK signals to the second RM coding unit 140b. Procedures are performed in parallel by both segmentation units 130a and 130b, a processing speed of the overall process can be increased.

### I. First Embodiment

### Ordering for Equally Distributing Bundling Signals

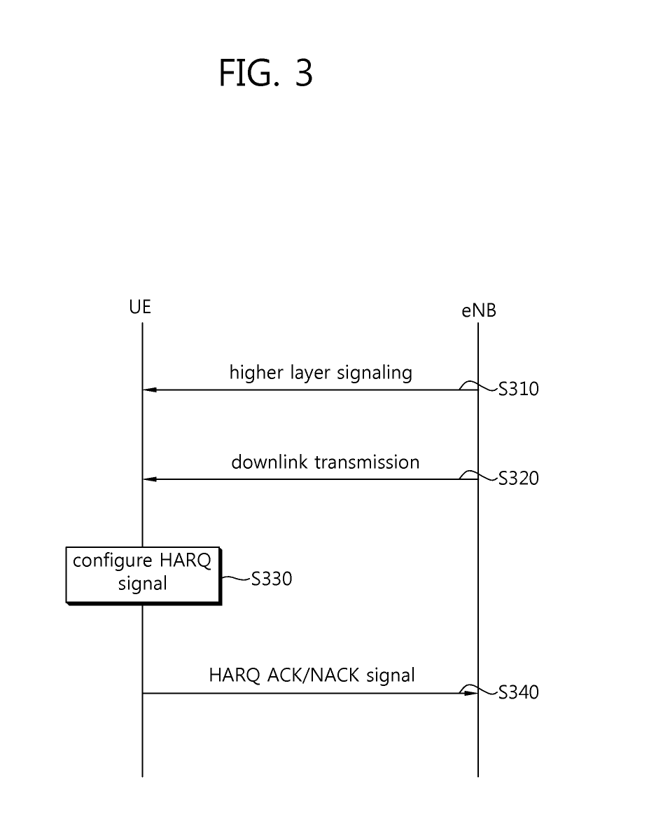

FIG. 3 is a flow chart illustrating an operation between a base station (BS) and a UE in a TDD system to which the present invention is applied.

A BS may transmit information required for transmitting HARQ ACK/NACK signals to a UE through higher layer signaling such as RRC signaling (S310). Here, the information required for the UE to transmit HARQ ACK/NACK signals includes information regarding a bundling method and/or a bundling target and information regarding ordering of the HARQ ACK/NACK signals. Meanwhile, information required for the UE to transmit the HARQ ACK/NACK signals may be determined in advance between the UE and the BS, in addition to the method of transmitting the information to the UE through higher layer signaling as mentioned above.

The BS transfers data to the UE through downlink transmission (S320). Information is transmitted on a control channel such as a PUCCH and a data channel such as a PDSCH through downlink transmission. The UE transmits HARQ ACK/NACK signals to the BS with respect to the information transmitted on the PDSCH.

The UE configures HARQ ACK/NACK signals with respect to the information received on the PDSCH (S330). In the TDD environment, in the case of transmitting HARQ ACK/NACK signals through the PUCCH format 3, if a payload size of the entire HARQ ACK/NACK signals exceeds 20 bits, the payload size is readjusted through bundling as described above to transmit the HARQ ACK/NACK signals. A bundling method performed by the UE and an ordering method for channel-coding the respective HARQ ACK/NACK signals in this case will be described later.

The UE transmits the configured HARQ ACK/NACK signals to the BS through the PUCCH format 3 (S340).

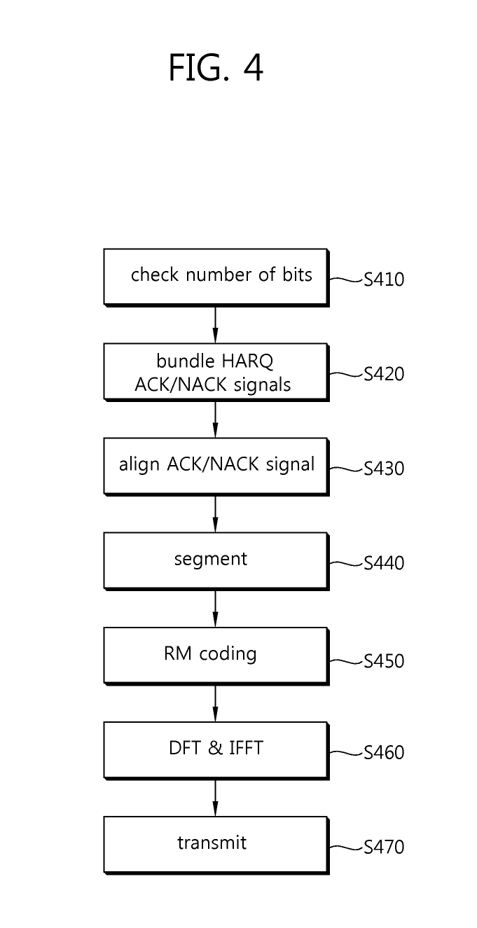

FIG. 4 is a flow chart schematically illustrating performing RM coding on HARQ ACK/NACK signals after going through bundling/ordering/segmentation in the UE of the system in order to transmit the signal.

A UE checks the number of bits of HARQ ACK/NACK signals to be transmitted (S410). When the entire HARQ ACK/NACK signals to be transmitted do not exceed 20 bits, the UE may multiplex the HARQ ACK/NACK signals through the PUCCH format 3 and transmit the same. When the HARQ ACK/NACK signals to be transmitted exceed 20 bits, the UE may need to perform bundling to transmit the HARQ ACK/NACK signals through the PUCCH format 3.

When the number of bits of the HARQ ACK/NACK signals to be transmitted exceeds 20 bits, the UE performs bundling on the HARQ ACK/NACK signals (S420).

Here, bundling may be performed in various manners.

The BS may specify targets to be bundled, and transmit information regarding the bundling targets to the UE through higher layer signaling. The BS may specify HARQ ACK/NACK signals as bundling targets in consideration of the number of bits of the entire HARQ ACK/NACK signals to be transmitted after being bundled, a communication environment, performance of the UE, and the like. For example, in order to avoid unnecessary retransmission, the BS may designate CCs of a downlink subframe having a poor channel state in which ACK/NACK signals with respect to two CWs are anticipated to be all NACK, to bundle HARQ ACK/NACK signals with respect to CWs transmitted in the corresponding CCs. At this time, the BS may estimate a downlink channel state on the basis of information regarding a CQI, RSRP/RSRQ, and the like, and reciprocity between uplink and downlink channels.

The BS designates HARQ ACK/NACK signals as bundling targets such that a payload size of the entire HARQ ACK/NACK signals to be transmitted is within a number of bits available for transmission, e.g., not exceeding 20 bits, according to the results of performing bundling.

Also, without specifying bundling targets, the BS may determine requirements regarding a start point at which bundling is to start, a performing direction, and an end point, and transfer the same to the UE. For example, the BS may indicate requirements regarding a start point such that bundling may be performed, starting from an HARQ ACK/NACK signal regarding a specific CC of a specific subframe—e.g., a PCC of the first received subframe. For example, the BS may indicate requirements regarding a performing direction such that bundling is performed along a frequency axis or a time axis. For example, the BS may indicate requirements regarding an end point such that a number of bits of the entire HARQ ACK/NACK signals to be transmitted does not exceed 20 bits or bundling is terminated when a predetermined number of bits arrives. Even in this case, the BS may determine an uplink channel state, and when the channel state is poor, the BS may perform bundling until when the number of HARQ ACK/NACK bits to be transmitted reaches an appropriate size, in order to increase transmission power per bit.

Information regarding bundling, e.g., HARQ ACK/NACK signals as bundling targets, a performing direction of bundling, an end point, and the like, may be determined according to A/N ordering and may be determined in advance between the UE and the BS or may be transferred from the BS to the UE through higher layer signaling such as RRC signaling.

When the HARQ ACK/NACK signals are bundled to reach a number of bits that can be transmittable through the PUCCH format 3, the UE orders the HARQ ACK/NACK signals (S430). Here, the bundled HARQ ACK/NACK signals may be represented by a representative HARQ ACK/NACK signal as described above.

As described above, in the system to which the present invention is applied, the HARQ ACK/NACK signals exceeding 20 bits are bundled and transmitted through the PUCCH format 3. Thus, the UE performs channel coding by using dual-RM coding. In this case, the UE may order the bundled HARQ ACK/NACK signals such that they are evenly distributed to both RM coders to thus equalize performance of both RM coders and effectively perform coding.

An ordering method of HARQ ACK/NACK signals according to an embodiment of thee present invention is as follows.

(1) Ordering of Bundled HARQ ACK/NACK Signals

A UE evenly distributes the bundled HARQ ACK/NACK signals to each of the dual-RM coders.

The UE may distribute the bundled HARQ ACK/NACK signals to each of the dual-RM coders alternately according to the bundled order. Also, the UE may order the bundled HARQ ACK/NACK signals such that they are distributed one by one to each RM coder according to order in a time axis or a frequency axis of subframes or CCs corresponding to each of the bundled HARQ ACK/NACK signals.

(2) Ordering of Unbundled HARQ ACK/NACK Signals

The UE evenly distributes unbundled HARQ ACK/NACK signals to each RM coder. Here, since the bundled HARQ ACK/NACK signals have already been distributed, the UE orders the other remaining unbundled HARQ ACK/NACK signals, excluding the bundled HARQ ACK/NACK signals.

The unbundled HARQ ACK/NACK signals may be ordered along the time axis or the frequency axis. Here, aligning of the HARQ ACK/NACK signals along the time axis means that HARQ ACK/NACK signals are aligned according to order in the time axis of subframes corresponding to the HARQ ACK/NACK signals. Here, aligning of the HARQ ACK/NACK signals along the frequency axis means that the HARQ ACK/NACK signals are ordered according to order in the frequency axis of the CCs corresponding to the HARQ ACK/NACK signals. In relation to how may unbundled HARQ ACK/NACK signals are to be distributed to each RM coder along the time axis or the frequency axis, HARQ ACK/NACK signals may be determined to be evenly distributed to each RM coder in consideration of a length of the entire HARQ ACK/NACK signals to be transmitted. Here, the entire HARQ ACK/NACK signals to be transmitted refers to HARQ ACK/NACK signals bundled such that they can be transmitted through the PUCCH format 3. For example, when the overall length is N., the HARQ ACK/NACK signals may be ordered is such that signals of ceil (N/2) are distributed to the first RM coder and signals of N-ceil (N/2) are distributed to the second RM coder.

The UE may order the unbundled HARQ ACK/NACK signals by interleaving them. Thus, the unbundled HARQ ACK/NACK signals may be ordered so as to be input to each RM coder alternately along the time axis by subframes. For example, an unbundled HARQ ACK/NACK signal with respect to a first subframe may be input to the first RM coder, and an unbundled HARQ ACK/NACK signal with respect to a second subframe may be input to the second RM coder. Also, the unbundled HARQ ACK/NACK signals may be ordered such that they may be input to each RM coder by CCs along the frequency axis. For example, an unbundled HARQ ACK/NACK signal with respect to a first CC may be input to the first RM coder, and an unbundled HARQ ACK/NACK signal with respect to a second CC may be input to the second RM coder.

A method of bundling downlink subframes to groups corresponding to the respective RM coders and ordering HARQ ACK/NACK signals with respect to subframes of the groups corresponding to the respective RM coders so as to be input may also be considered. In this case, the groups of the subframes may be formed such that numbers of bundled HARQ ACK/NACK signals corresponding to subframes of each group are the same or equal as much as possible.

Information regarding the method for ordering the HARQ ACK/NACK signals as described above may be determined in advance between the UE and the BS or may be transferred to the UE through higher layer signaling.

Meanwhile, it has been described that the HARQ ACK/NACK signals are equally distributed to the RM coders, but, besides, various other methods may also be employed. For example, bundled HARQ ACK/NACK signals may be concentrated on one RM coder.

The ordered HARQ ACK/NACK signals are segmented in units of channel coding (S440). The HARQ ACK/NACK signals are segmented according to the ordered sequence and input to each RM coder. Here, in order to increase an overall processing speed as described above, segmentation devices corresponding to the number of RM coders may be used. In the case of using segmentation devices for each RM coder, the process of segmenting the HARQ ACK/NACK signals and inputting them to each RM coder may be performed in parallel.

Each RM coder performs RM coding (S450). Modulation symbols output from each RM coder are interleaved, DFT-processed, and subsequently IFFT-processed (S460).

Subsequently, the HARQ ACK/NACK signals are transmitted in two slots through the PUCCH format 3 (S470).

Hereinafter, a first embodiment in which HARQ ACK/NACK signals are ordered in consideration of bundling will be described in detail.

Referring to FIGS. 1 and 2 as described above, HARQ ACK/NACK signals are bundled by the bundling unit 110 and ordered by the ordering unit 120. The HARQ ACK/NACK signals are segmented according to the ordered sequence and input to the RM coders.

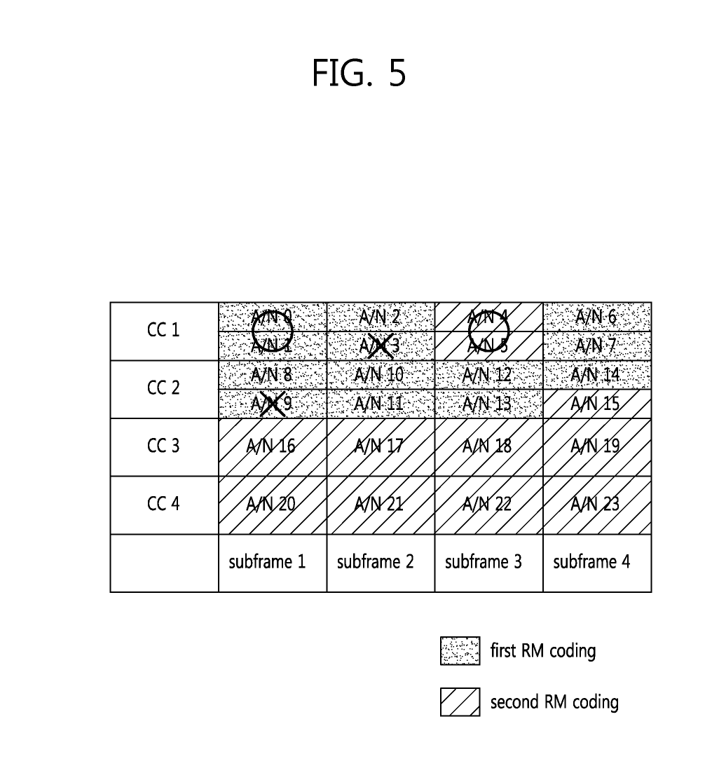

FIGS. 5 through 9 are views schematically illustrating bundling and ordering performed on HARQ ACK/NACK signals in the system to which the present invention is applied. FIGS. 5 through 9 shows bundling and ordering of corresponding HARQ ACK/NACK signals in consideration of disposition of subframes and CCs in a case in which four downlink subframes are associated with one uplink subframe and four CCs are transmitted in each subframe.

In FIGS. 5 through 9, it is assumed that CC1 and CC2, among CCs, are able to transmit 2CW for the description purpose. ‘A/N’ refers to an HARQ ACK/NACK signal with respect to a CW transmitted by a CC in a corresponding subframe, and a number next to ‘A/N’ indicates ordering order. A circle (∘) indicates that the corresponding HARQ ACK/NACK signals have been bundled. ‘X’ indicates that a corresponding CC may be able to transmit 2CW but it has been scheduled that only 1CW is transmitted in the corresponding subframe. Thus, the HARQ ACK/NACK signals with respect to the CW indicated by ‘X’ are not transmitted.

For the description purpose, FIGS. 5 through 9 show a case in which, in order to transmit HARQ ACK/NACK signals through the PUCCH format, the HARQ ACK/NACK signals are bundled twice such that a payload size does not exceed 20 bits, but content described in the following embodiment may also be applied in the same manner even to a case in which bundling is additionally performed.

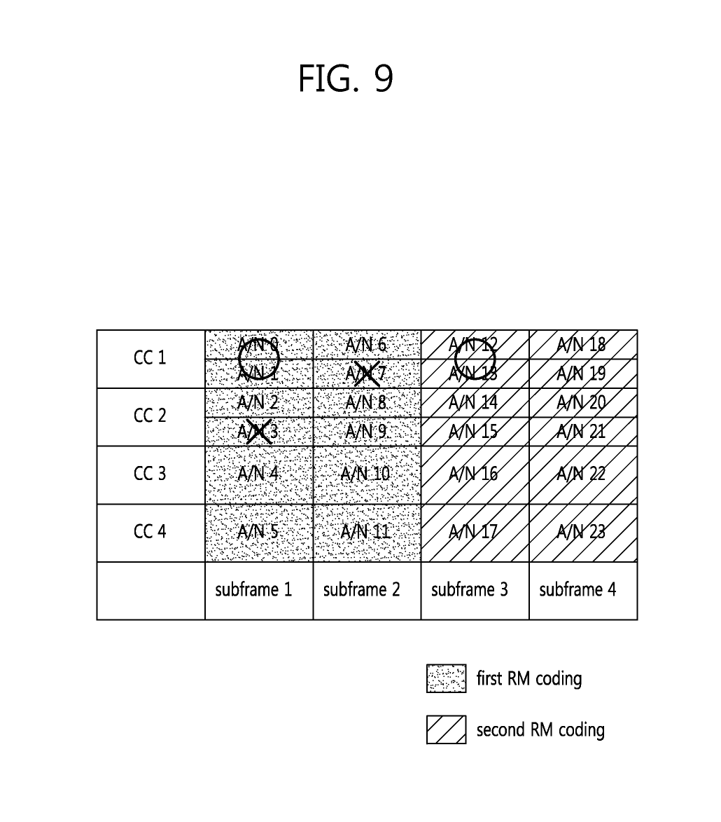

Also, bundling targets may be determined in advance between the UE and the BS according to a predetermined scheme or may be transferred to the UE through higher layer signaling. For the description purpose, in FIGS. 5 through 9, it is assumed that bundling is performed in subframe 1 and subframe 3. In the case illustrated in FIGS. 5 and 9, in order to make the number of bits of HARQ ACK/NACK signals 20 bits or smaller, bundling is required to be performed twice. Thus, when bundling is performed in the subframe 1 and the subframe 3 once, additional bundling is not required.

FIG. 5 illustrates an embodiment in which HARQ ACK/NACK signals are ordered along a time axis.

Referring to FIG. 5, in subframe 1, HARQ ACK/NACK signals A/N0 and A/N1 with respect to CC1 are bundled in subframe 1 and ordered so as to be distributed to the first RM coding unit. Also, HARQ ACK/NACK signals A/N4 and A/N4 with respect to CC1 are bundled in subframe 3 and ordered so as to be distributed to the second RM coding unit. Thus, the bundled HARQ ACK/NACK signals are evenly distributed to the dual-RM coders, respectively.

The HARQ ACK/NACK signals may be ordered such that the bundled HARQ ACK/NACK signals are first input and unbundled HARQ ACK/NACK signals are subsequently input to each RM coder.

The unbundled HARQ ACK/NACK signals are ordered in sequence along the time axis. Since the HARQ ACK/NACK signals corresponding to the CC1 of the subframe 1 and the HARQ ACK/NACK signals corresponding to CC1 of the subframe 3 have been already bundled and distributed to the first RM coder and the second RM coder, they are excluded from ordering of unbundled HARQ ACK/NACK signals. Thus, unbundled HARQ ACK/NACK signals are ordered to be first input to the first RM coder along the time axis, starting from the CC1 of the subframe 2. When the ordering of the HARQ ACK/NACK signals corresponding to the subframe 1 to the subframe 4 with respect to the same CC is completed, HARQ ACK/NACK signals may be ordered along the time axis with respect to a next CC. HARQ ACK/NACK signals to be input to the second RM coder are also ordered along the time axis.

Here, since CC1 has been scheduled to transmit 1CW in the subframe 2 and CC2 has been scheduled to transmit 1CW in the subframe 1, A/N3 and A/N9 are not transmitted. Here, even in case of a transmission mode (MIMO transmission mode) supporting two transport blocks, if it has been scheduled to transmit one CW, it is made a rule not to apply spatial bundling.

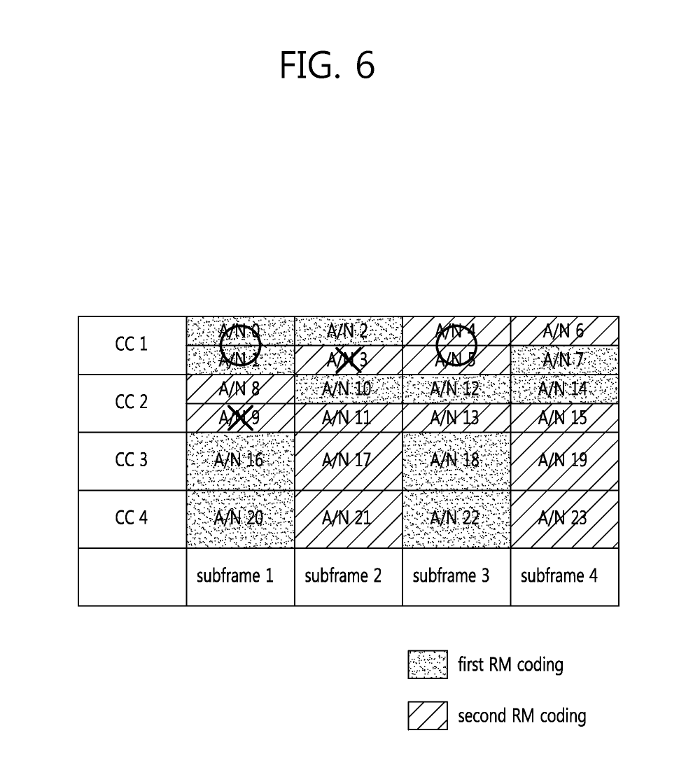

FIG. 6 illustrates an embodiment in which HARQ ACK/NACK signals are ordered along the time axis by applying interleaving.

Referring to FIG. 6, HARQ ACK/NACK signals A/N0 and A/N1 with respect to the CC1 in the subframe 1 are order to be bundled and distributed to the first RM coding unit. Also, the HARQ ACK/NACK signals A/N4 and A/N5 with respect to the CC1 in the subframe 3 are ordered to be bundled and distributed to the second RM coding unit. Thus, the bundled HARQ ACK/NACK signals are evenly distributed to the dual-RM coders.

The HARQ ACK/NACK signals may be ordered such that bundled HARQ ACK/NACK signals are first input to each RM coder and unbundled HARQ ACK/NACK signals are subsequently input.

The unbundled HARQ ACK/NACK signals are interleaved along the time axis. Since the HARQ ACK/NACK signals corresponding to the CC1 of the subframe 1 and the HARQ ACK/NACK signals corresponding to the CC1 of the subframe 3 have already been bundled and distributed to the first RM coder and the second RM coder, they are excluded from the ordering of the unbundled HARQ ACK/NACK signals. Thus, HARQ ACK/NACK signals with respect to each CW start to be ordered, starting from CC1 of the subframe 2. Since interleaving is applied, the unbundled HARQ ACK/NACK signals corresponding to each CW are ordered to be alternately input to the first RM coder and the second RM coder along the time axis. When the ordering of the HARQ ACK/NACK signals corresponding to the subframe 1 to subframe 4 with respect to the same CC is completed, the HARQ ACK/NACK signals may be ordered with respect to a next CC along the time axis.

Here, the CC1 has been scheduled to transmit 1CW in the subframe 2 and the CC2 has been scheduled to transmit 1CW in the subframe 1, A/N3 and A/N7 are not transmitted.

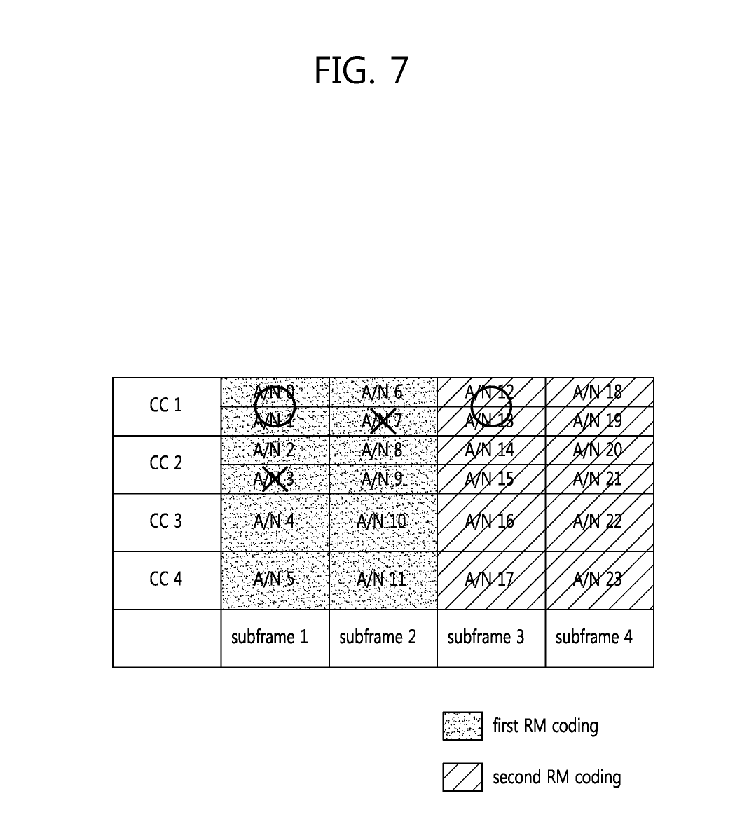

FIG. 7 illustrates an embodiment of ordering HARQ ACK/NACK signals along a frequency axis.

Referring to FIG. 7, HARQ ACK/NACK signals A/N0 and A/N1 with respect to CC1 of subframe 1 are ordered to be bundled and distributed to the first RM coding unit. Also, HARQ ACK/NACK signals A/N12 and A/N13 with respect to CC1 of subframe 3 are ordered to be bundled and distributed to the second RM coding unit. Thus, the bundled HARQ ACK/NACK signals are evenly distributed to each of the dual-RM coders.

The HARQ ACK/NACK signals may be ordered such that the bundled HARQ ACK/NACK signals are first input and unbundled HARQ ACK/NACK signals are subsequently input to each RM coder.

The unbundled HARQ ACK/NACK signals are ordered in sequence along the frequency axis. Since the HARQ ACK/NACK signals corresponding to the CC1 of the subframe 1 and the HARQ ACK/NACK signals corresponding to CC1 of the subframe 3 have been already bundled and distributed to the first RM coder and the second RM coder, they are excluded from ordering of unbundled HARQ ACK/NACK signals. Thus, unbundled HARQ ACK/NACK signals are ordered to be first input to the first RM coder along the frequency axis, starting from the CC2 of the subframe 1. When the ordering of the HARQ ACK/NACK signals corresponding to the CC1 to CC4 with respect to the same subframe is completed, HARQ ACK/NACK signals may be ordered along the frequency axis with respect to a next subframe. HARQ ACK/NACK signals to be input to the second RM coder are also ordered along the frequency axis.

Here, since CC1 has been scheduled to transmit 1CW in the subframe 2 and CC2 has been scheduled to transmit 1CW in the subframe 1, A/N3 and A/N9 are not transmitted.

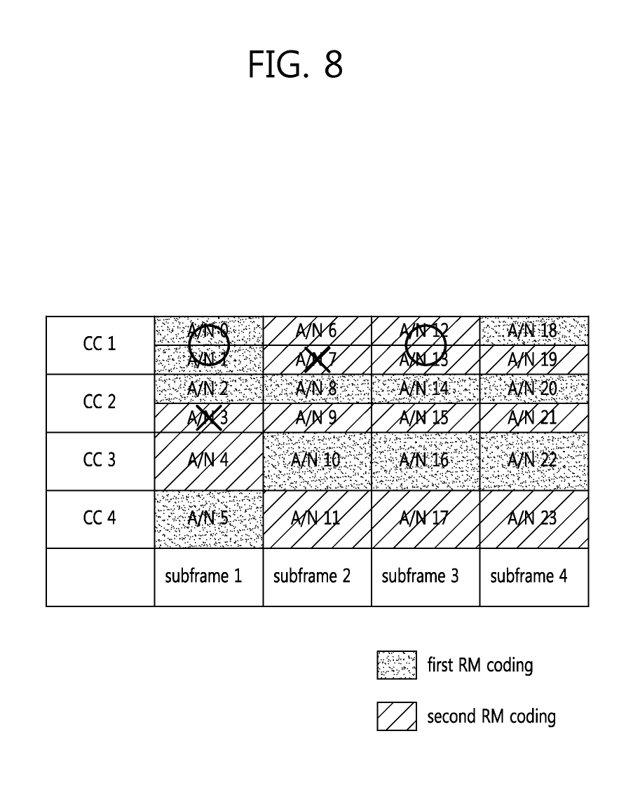

FIG. 8 illustrates an embodiment of ordering HARQ ACK/NACK signals by applying interleaving, along the frequency axis.

Referring to FIG. 8, HARQ ACK/NACK signals A/N12 and A/N13 with respect to the CC1 in the subframe 1 are order to be bundled and distributed to the first RM coding unit. Also, the HARQ ACK/NACK signals A/N4 and A/N5 with respect to the CC1 in the subframe 3 are ordered to be bundled and distributed to the second RM coding unit. Thus, the bundled HARQ ACK/NACK signals are evenly distributed to the dual-RM coders.

The HARQ ACK/NACK signals may be ordered such that bundled HARQ ACK/NACK signals are first input to each RM coder and unbundled HARQ ACK/NACK signals are subsequently input.

The unbundled HARQ ACK/NACK signals are interleaved along the frequency axis. Since the HARQ ACK/NACK signals corresponding to the CC1 of the subframe 1 and the HARQ ACK/NACK signals corresponding to the CC1 of the subframe 3 have already been bundled and distributed to the first RM coder and the second RM coder, they are excluded from the ordering of the unbundled HARQ ACK/NACK signals. Thus, HARQ ACK/NACK signals with respect to each CW start to be ordered, starting from CC2 of the subframe 1. Since interleaving is applied, the unbundled HARQ ACK/NACK signals corresponding to each CW are ordered to be alternately input to the first RM coder and the second RM coder along the frequency axis. When the ordering of the HARQ ACK/NACK signals corresponding to the CC1 to CC4 with respect to the same subframe is completed, the HARQ ACK/NACK signals may be ordered with respect to a next CC along the frequency axis.

Here, the CC1 has been scheduled to transmit 1CW in the subframe 2 and the CC2 has been scheduled to transmit 1CW in the subframe 1, A/N3 and A/N7 are not transmitted.

FIG. 9 illustrates an embodiment of grouping subframes by equal number and ordering HARQ ACK/NACK signals such that they correspond to each RM coder by groups.

Referring to FIG. 9, downlink subframes are classified into a group (subframe 1 and subframe 2) corresponding to the first RM coder and a group (subframe 3 and subframe 4) corresponding to the second RM coder, and HARQ ACK/NACK signals with respect to the subframes of the groups corresponding to each RM coder are order to be input. Here, in each group, the number of bundled HARQ ACK/NACK signals may be the same or as equal as possible.

In the case of FIG. 9, it can be seen that the number of bundled HARQ ACK/NACK signals of the group corresponding to the first RM coder and that of the group corresponding to the second RM coder are the same as 1.

In FIG. 9, it is illustrated that the subframes 1 and 2 are grouped and the subframes 3 and 4 are grouped, but the present invention is not limited thereto. For example, even in the case of FIG. 9, the subframes 1 and 4 may be grouped and the subframes 2 and 3 are grouped such that the bundled HARQ ACK/NACK signals are evenly distributed in number to each group and the technical concept of the present invention may be applied in the same manner.

So far, the embodiment of FIGS. 5 through 9, four downlink subframes are associated with a single uplink subframe and four CCs are transmitted in each subframe have been described, and in this case, two CCs, among CCs, are able to transmit 2CW, but this is merely for the description purpose and the present invention is not limited thereto but applied in the same to various other downlink subframes and a CA environment.

### II. Second Embodiment

### Ordering in Consideration of Activation of CC

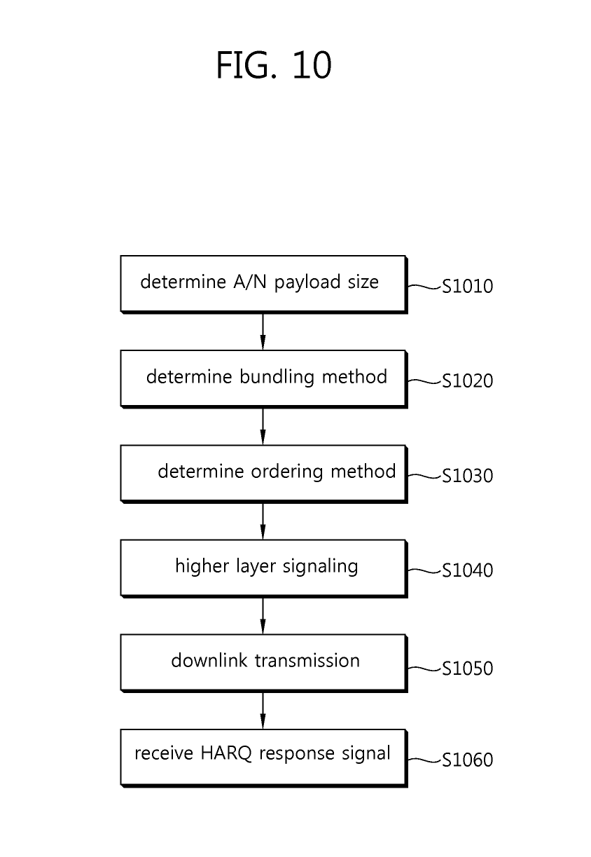

FIG. 10 is a flow chart illustrating an operation performed by a BS in a case in which a UE bundles HARQ ACK/NACK signals having 20 or more bits through a PUCCH is format 3 and transmits the same in the TDD system.

A BS determines a payload size (codebook size) of HARQ ACK/NACK signals to be transmitted by a UE (S1010). The BS may determine a codebook size in consideration of a number of downlink subframes associated with one uplink subframe, a number of component carriers configured in the downlink subframes associated with the one uplink subframe, a transmission mode of each CC (whether to transmit 1CW or 2CW by one CC in one downlink subframe), uplink grant, a scheme of spatial bundling to be used (whether to apply full bundling or whether to apply partial bundling), and the like.

When a size of the HARQ ACK/NACK signals to be transmitted by the UE exceeds 20 bits as in the case to which the present invention is applied, the UE may bundle the HARQ ACK/NACK signals and transmit the same through the PUCCH format 3.

The BS determines a bundling method in consideration of the determined payload size of the HARQ ACK/NACK signals (S1020).

In order to transmit the HARQ ACK/NACK signals through the PUCCH format 3, the BS may determine whether to apply full bundling or whether to apply partial bundling. Here, the full bundling refers to bundling every HARQ ACK/NACK signal with respect to 2CW transmitted by CCs that transmit 2CW in each downlink subframe associated with one uplink subframe. Also, partial bundling refers to bundling only HARQ ACK/NACK signals with respect to 2CW transmitted by some of CCs that transmit 2CW in each downlink subframe associated with one uplink subframe.

Here, the BS may determine in which way bundling is to be performed when partial bundling is applied. For example, the BS may determine up to which number of bits of the entire HARQ ACK/NACK signals bundling is to be performed to transmit the HARQ ACK/NACK signals through the PUCCH format 3, from which HARQ ACK/NACK signal with respect to which CC of which subframe bundling is to be performed, and the like.

Also, after the payload size of the HARQ ACK/NACK signals to be transmitted by the UE is determined in consideration of a bundling method, the BS may determine to perform bundling according to the corresponding bundling method.

The BS may determine a method of ordering the bundled HARQ ACK/NACK signals (S1030).

The BS may order the bundled HARQ ACK/NACK signals such that they are concentrated on one RM coder or may be evenly distributed to the two RM coders.

The BS may transmit information regarding an HARQ ACK/NACK signal configuration and/or transmission method including a bundling method and an ordering method to the UE through higher layer signaling such as RRC signaling (S1040). Here, the method of transferring, by the BS, required information to the UE through higher layer signaling is taken as an example, but the present invention is not limited thereto and a portion or the entirety of the information required for the UE to configure and transmit HARQ ACK/NACK signals may be determined in advance between the UE and the BS.

The BS transfers data to the UE through downlink transmission (S1050). The BS may transmit data on a downlink control channel (PDCCH) and a downlink transport channel (PDSCH).

The BS receives an HARQ ACK/NACK signal with respect to the transmitted PDSCH (S1060). The HARQ ACK/NACK signal received by the BS has been configured and transmitted according to the HARQ ACK/NACK signal configuration and transmission method indicated by the BS. The BS may successfully decode according to the method of indicating the received HARQ ACK/NACK signal, and cope with it.

Meanwhile, even in this case, a specific operation of the UE is the same as described above with reference to FIG. 4. However, in relation to the operation of the BS related to the operation of the UE of FIG. 4, the operation of the BS according to the present embodiment is the same as described above with reference to FIG. 10.

Hereinafter, a method of bundling and ordering HARQ ACK/NACK signals having 20 bits or greater to transmit the same through the PUCCH format 3 in the system to which the present invention is applied will be described in detail.

<Bundling Method>

In Case that all CCs are Activated

A BS may determine whether to perform full bundling or partial bundling in consideration of a codebook size of HARQ ACK/NACK signals to be transmitted by a UE, a communication environment, and the like.

When the BS determines to perform full bundling, the UE bundles HARQ ACK/NACK signals with respect to two CWs transmitted by each CC into one representative value, with respect to all the CCs that transmit 2CW in downlink subframes associated with one uplink subframe as described above.

When the BS determines to perform partial bundling, the BS may specify a bundling target.

The BS may specify a bundling target in consideration of the number of bits of the entire HARQ ACK/NACK signals to be transmitted after being bundled. The BS may designate HARQ ACK/NACK signals as bundling targets such that a payload size of the entire HARQ ACK/NACK signals to be transmitted does not exceed 20 bits, according to the results of performing bundling.

Also, without specifying bundling targets, the BS may determine requirements regarding a start point at which bundling is to start, a performing direction, and an end point, and transfer the same to the UE. Regarding a start point, for example, the BS may indicate requirements regarding a start point such that bundling may be performed, starting from an HARQ ACK/NACK signal regarding a specific CC of a specific subframe—e.g., a PCC of the first received subframe. Regarding an end point, for example, the BS may indicate requirements regarding a performing direction such that bundling is performed along a frequency axis or a time axis. Regarding a performing direction, for example, the BS may indicate requirements regarding an end point such that a number of bits of the entire HARQ ACK/NACK signals to be transmitted does not exceed 20 bits or bundling is terminated when a predetermined number of bits arrives.

Also, the BS may specify HARQ ACK/NACK signals as bundling targets in consideration of a communication environment, performance of the UE, and the like. For example, in order to avoid unnecessary retransmission, the BS may designate CCs of a downlink subframe having a poor channel state in which ACK/NACK signals with respect to two CWs are anticipated to be all NACK, to bundle HARQ ACK/NACK signals with respect to CWs transmitted in the corresponding CCs. At this time, the BS may estimate a downlink channel state on the basis of information regarding a CQI, RSRP/RSRQ, and the like, and reciprocity between uplink and downlink channels.

The BS may determine an uplink channel state, and when the channel state is poor, the BS may perform bundling until when the number of HARQ ACK/NACK bits to be transmitted reaches an appropriate size, in order to increase transmission power per bit.

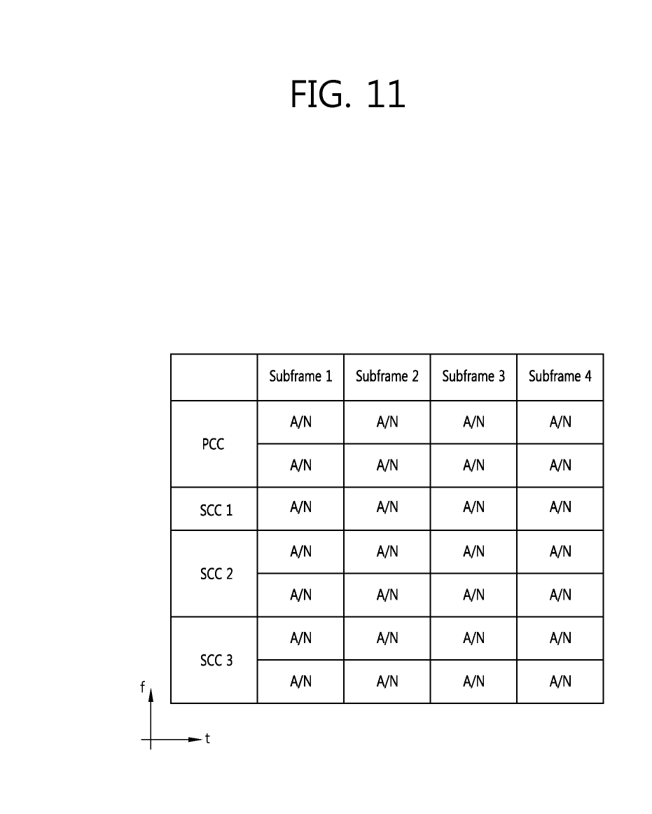

FIG. 11 is a view illustrating HARQ ACK/NACK signals with respect to component carriers (CCs) in respective subframes in a case in which all the CCs are activated. Referring to FIG. 11, among a primary component carrier (PCC) and secondary component carriers (SCCs), a transmission mode of two CCs SCC2 and SCC3 are determined to transmit 2CW each time.

The BS may instruct full bundling such that all the HARQ ACK/NACK signals regarding the PCC, the SCC1 and the SCC2 that transmit 2CW are bundled.

Also, the BS may instruct partial bundling such that the number of bits of the entire HARQ ACK/NACK signals to be transmitted does not exceed 20 bits. In this case, the BS may specifically indicate bundling targets or designate (a) a start point of bundling, (2) a performing direction of bundling, and (3) an end point of bundling.

For example, the BS may instruct performing bundling, (1) starting from an HARQ ACK/NACK signal with respect to a first received subframe (subframe 1) of the PCC, (2) in a time axis direction, (3) until when the number of bits of the HARQ ACK/NACK signals to be transmitted does not exceed 20 bits. In this case, when bundling of the HARQ ACK/NACK signals with respect to one CC in the time axis direction is terminated, bundling of HARQ ACK/NACK signals may be performed along the time axis with respect to a subsequent CC. Here, for the description purpose, the start point, the performing direction, and the end point have been described but the bundling method is not limited thereto, and the start point may be designated through each CC and subframe, various performing directions such as a time axis, a frequency axis, and the like, may be designated, and various end points such as until when the number of bits of the HARQ ACK/NACK signals to be transmitted ‘does not exceed 20 bits’, until when the number of bits of the HARQ ACK/NACK signals to be transmitted reaches a ‘particular number of bits’, and the like.

In Case that Some CCs are Deactivated

Some of CCs configured in the CA environment may not be activated. CCs are activated or deactivated in units of CCs. Thus, in order to configure and transmit an HARQ response signal in the CA environment, deactivated CCs are required to be considered.

Bits indicating DTX (Discontinuous Transmission) or NACK may be transmitted as an HARQ response signal with respect to a deactivated CC. In the present embodiment, when an HARQ response signal to be transmitted exceeds 20 bits, bundling is performing on CCs including a deactivated CC in order to transmit the HARQ response signal through the PUCCH format 3. Thus, bits indicating DTX (Discontinuous Transmission) or NACK are bundled so as to be indicated as a representative value. To which representative value, the bits are to be bundled may be determined in advance between a UE and a BS or may be transferred to the UE through higher layer signaling.

In the present embodiment, in a case in which CCs that may be able to transmit 2CW, among CCs, are set but there is a deactivated CC, an HARQ response signal with respect to the deactivated CC is first bundled. Since the HARQ response signal with respect to the deactivated CC is first bundled, the HARQ ACK/NACK signals with respect to the activated CCs can be multiplexed as many as possible and transmitted, without being bundled.

Even after the HARQ response signal with respect to a deactivate CC is bundled, an additional bundling may be required. For example, additional bundling may be required when the number of bits of an HARQ response signal to be transmitted still exceeds 20 bits or transmission power per bit is required to be increased in consideration of a communication environment, in a case in which an HARQ response signal is transmitted through the PUCCH format 3.

When additional bundling is required, among different CCs transmitted in downlink subframes associated with an uplink subframe for transmitting an HARQ response signal, HARQ ACK/NACK signals with respect to CCs that transmit 2CW may be bundled. In this case, additional bundling may be performed according to any one of predetermined references as follows.

Reference (1): when a PCC is a CC that transmits 2CW, HARQ ACK/NACK signals with respect to the PCC are first bundled. Subsequently, targets are selected from among SCCs that transmit 2CW in ascending order and bundling is performed thereon.

Reference (2): Among CCs that may be able to transmit 2CW, HARQ ACK/NACK signals with respect to CCs having more subframes that transmit 2CW actually are first bundled.

Reference (3): Bundling is performed sequentially, starting from HARQ ACK/NACK signals with respect to a CC having a great value of V^{DL}_{DAI}, according to the value V^{DL}_{DAI} as a variable indicating a maximum number of subframes in which a PDSCH is transmitted, among CCs that transmit 2CW.

Whether to perform additional bundling by applying any one of the foregoing predetermined bundling references (1) to (3) may be determined in advance between a UE and a BS or the BS may determine it and transfer it through higher layer signaling.

<Ordering Method>

As described above, in the system to which the present invention is applied, HARQ ACK/NACK signals exceeding 20 bits are bundled and transmitted through the PUCCH format 3. Thus, the UE performs channel coding by using dual-RM coding.

In an embodiment of the present invention, CCs that may be able to transmit 2CW, among CCs of downlink subframes associated with one uplink subframe, is set, but if there is a deactivated CC, an HARQ response signal with respect to the deactivated CC is first bundled, so that the HARQ ACK/NACK signals with respect to the activated CCs can be multiplexed as many as possible and transmitted, without being bundled.

Hereinafter, ordering in a case in which partial bundling is performed when CCs that may be able to transmit 2CW, among CCs of downlink subframes associated with one uplink subframe, are set but there is a deactivated CC will be described.

Ordering is performed on the entire transmission-object HARQ response signals including a bundled HARQ response signal and an HARQ response signal which is not a bundling target.

Ordering may be performed along a time axis or a frequency axis or may be performed by grouping, or interleaving may be applied thereto, in consideration of downlink subframes associated with an uplink subframe in which an HARQ response signal is transmitted and CCs transmitted in the downlink subframes.

In a case in which HARQ response signals are transmitted through the PUCCH format 3 by using dual-RM coders, a UE may order the bundled HARQ response signals such that they are evenly distributed to both RM coders or may order the bundled HARQ response signals such that they are concentrated on a single RM coder.

In order to make the bundled HARQ response signals concentrated on one RM coder, ordering may be performed along the time axis.

In order to make the bundled HARQ response signals evenly distributed to both RM coders, ordering may be performed along the frequency axis, ordering may be performed by applying interleaving, or ordering may be performed by grouping HARQ response signals according to subframes.

Hereinafter, a specific method of bundling and ordering according to an embodiment of the present invention will be described according to ordering types with reference to the accompanying drawings.

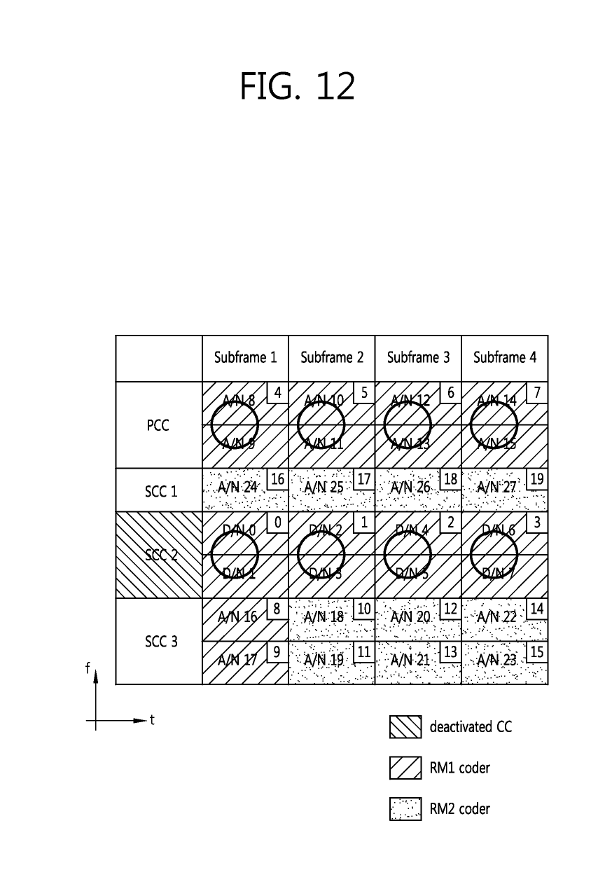

FIGS. 12 through 36 are views schematically illustrating bundling and ordering performed on HARQ ACK/NACK signals in the system to which the present invention is applied. In FIGS. 12 through 36, corresponding HARQ ACK/NACK signals are bundled and ordered in consideration of dispositions of subframes and CCs in a case in which four downlink subframes are associated with one uplink subframe and four CCs (one is a PCC and the other three are SCCs) are transmitted in each subframe.

In FIGS. 12 through 36, for the description purpose, it is assumed that, among the CCs, a PCC and two SCCs (SCC2 and SCC3) are set as CCs that may be able to transmit 2CW. It is assumed that, among them, the SCC2 is a deactivated CC.

In FIGS. 12 through 36, ‘A/N’ refers to an HARQ ACK/NACK signal with respect to a CW transmitted by a CC in a corresponding subframe, and ‘D/N’ is a bit indicating DTX or NACK. A circle (∘) indicates that the corresponding HARQ ACK/NACK signals have been bundled. ‘X’ indicates that a corresponding CC has been scheduled to transmit 2CW but not a corresponding codeword or scheduled not to be transmitted in a corresponding subframe. Thus, with respect to the CW indicated by X, HARQ ACK/NACK signal with respect to reception of a PDSCH is not transmitted, and a corresponding predetermined bit may be transmitted. Numbers next to ‘A/N’ and ‘D/N’ indicate ordering order, and numbers within small boxes indicate ordering order in consideration of bundling.

For the description purpose, in FIGS. 12 through 36, in order to transmit HARQ response signals through the PUCCH format 3, bundling is performed eight times to prevent a payload size of the entire HARQ response signals from exceeding 20 bits, but when bundling is additionally performed or when setting of downlink subframes associated with an uplink subframe and that of CCs are different so bundling is performed a greater or smaller number of times, content described in the following embodiment may also be applied in the same manner.

<Ordering Scheme 1—Concentrating Bundled Signals on One RM Coder>

HARQ response signals with respect to a deactivated CC are first bundled, and when additional bundling is required, bundling is performed according to any one of the foregoing predetermined references (1) to (3). In order to make the bundled HARQ response signals concentrated on one RM coder, the HARQ response signals may be ordered along a time axis according to bundled order.

FIG. 12 illustrates a case in which ordering is performed along a time axis and additional ordering is performed according to the reference (1).

Referring to FIG. 12, first, bundling is performed on HARQ response signals corresponding to the deactivate CC SCC2. Additional bundling is performed on HARQ ACK/NACK signals corresponding to the PCC.

Subsequently, in order to allow the bundled HARQ response signals to be concentratively input to the first RM coder, the bundled HARQ response signals are ordered along the time axis in FIG. 12 such that an HARQ response signal with respect to the first bundled SCC2 is input to the first coder. Subsequently, the HARQ response signals bundled with respect to the PCC are ordered along the time axis of FIG. 12 such that they are input to the first coder.

When ordering of the HARQ response signals input to the first RM coder is finished, HARQ response signals to be input to the second RM coder are ordered along the time axis of FIG. 12. As for ordering order of SCC1 and SCC3 in which corresponding HARQ ACK/NACK signals are not bundling targets, the HARQ ACK/NACK signals with respect to the SCC3 in which 2CW transmission is scheduled may be first ordered although it has not been bundled, in order to perform ordering according to bundling order, or, simply, HARQ ACK/NACK signals with respect to the SCC1 may be first bundled in consideration of ascending order with respect to indices of CCs.

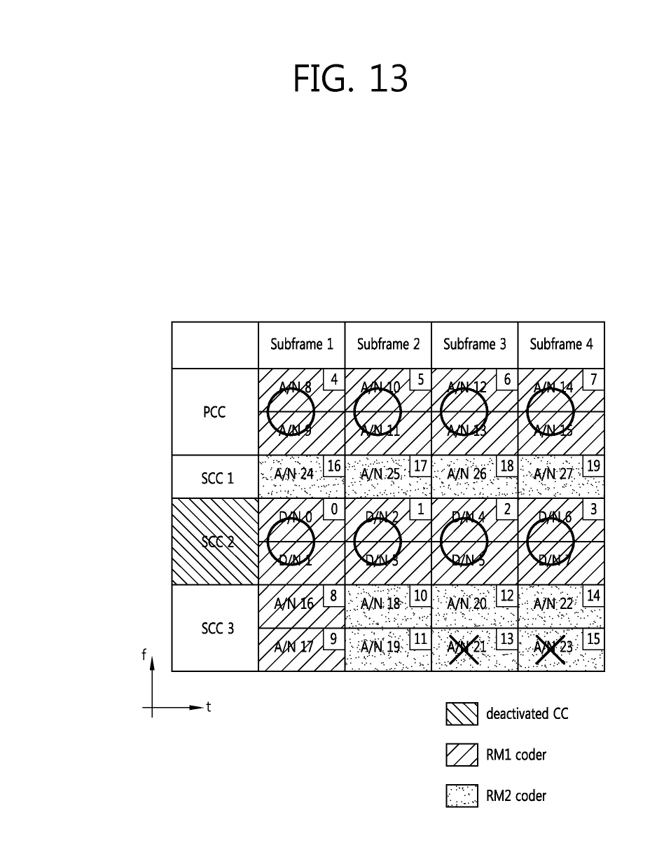

FIG. 13 illustrates an example in which ordering is performed along the time axis and additional ordering is performed according to the reference (2).

Referring to FIG. 13, unlike the case of FIG. 12, it can be seen that transmission of 2CW is more frequently made in the PCC actually, among the PCC and the SCC3 that may be able to transmit 2CW. Thus, after bundling HARQ response signals with respect to deactivate CCs, additional bundling is performed on the HARQ ACK/NACK signals of the PCC and ordering is performed according to the bundling order.

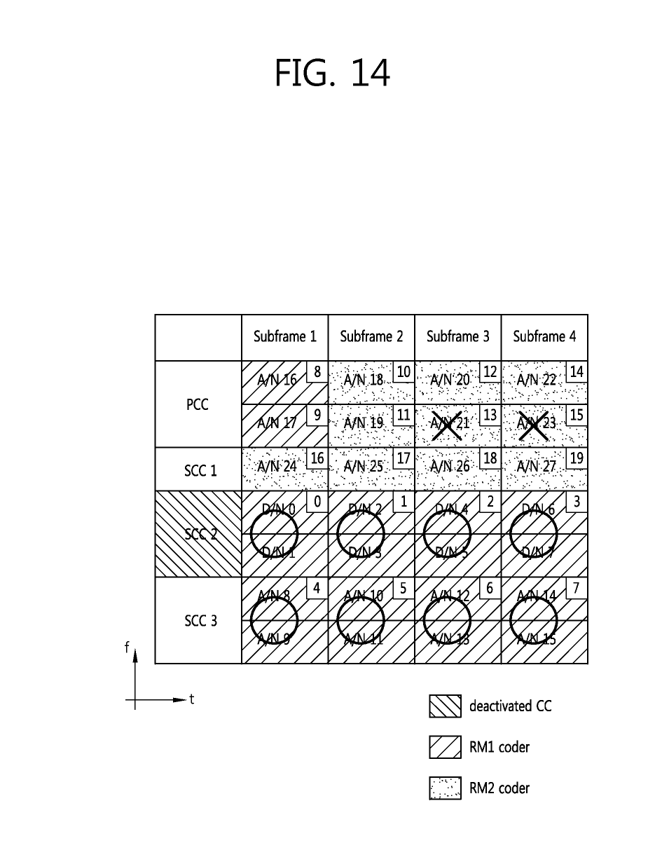

FIG. 14 illustrates another example in which ordering is performed along the time axis and additional ordering is performed according to the reference (2).

Referring to FIG. 14, unlike the case of FIG. 13, it can be seen that transmission of 2CW is more frequently made in the SCC3 actually, among the PCC and the SCC3 that may be able to transmit 2CW. Thus, after bundling HARQ response signals with respect to deactivate CCs, additional bundling is performed on the HARQ ACK/NACK signals of the SCC3 and ordering is performed in order different from that of the case of FIG. 13, according to the bundling order.

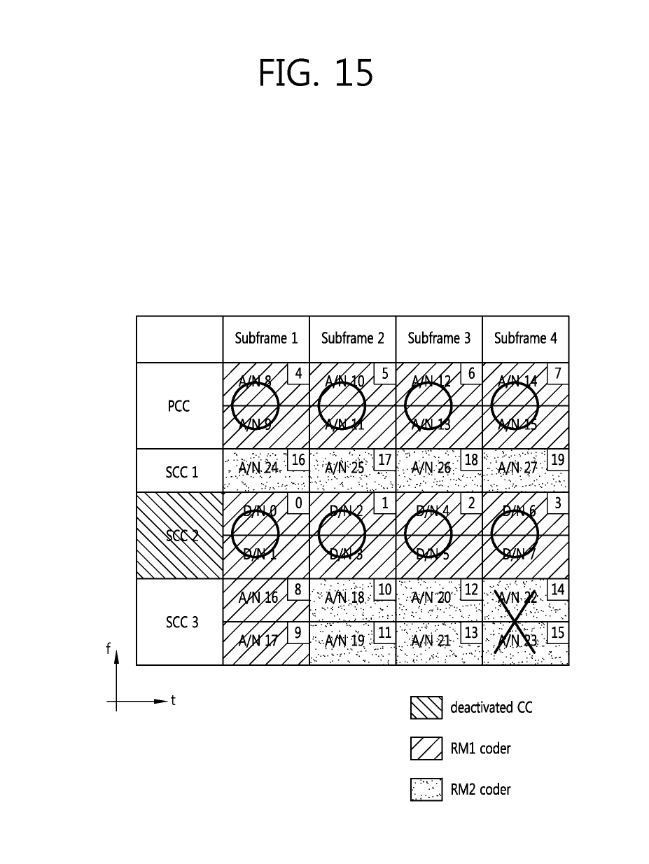

FIG. 15 illustrates an example in which ordering is performed along the time axis and additional ordering is performed according to the reference (3).

Referring to FIG. 15, it can be seen that transmission of 2CW is more frequently made in the PCC, among the PCC and the SCC3 that may be able to transmit 2CW. Thus, after bundling HARQ response signals with respect to deactivate CCs, additional bundling is performed on the HARQ ACK/NACK signals of the PCC and ordering is performed according to the bundling order.

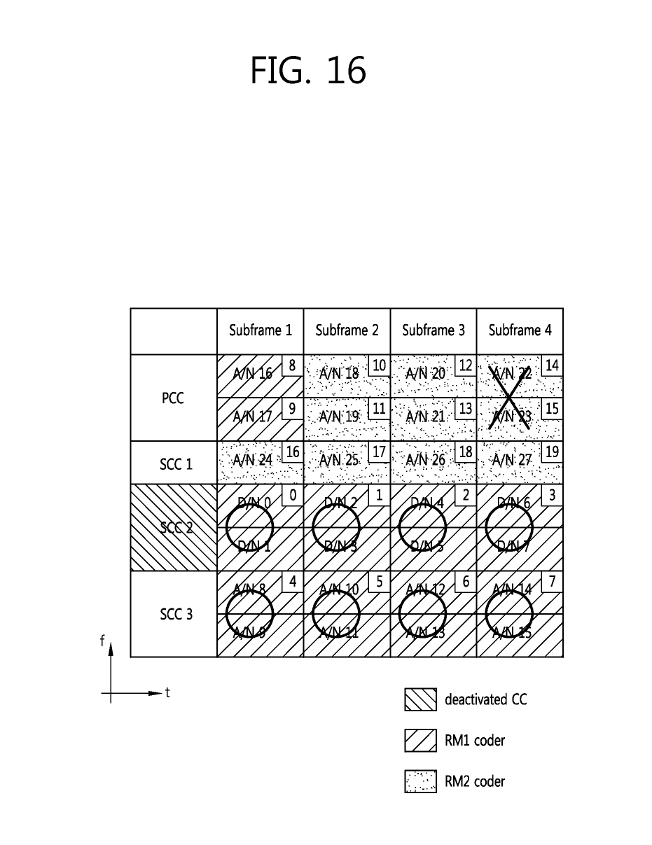

FIG. 16 illustrates another example in which ordering is performed along the time axis and additional ordering is performed according to the reference (3).

Referring to FIG. 16, unlike the case of FIG. 15, it can be seen that transmission of 2CW is more frequently made in the SCC3, among the PCC and the SCC3 that may be able to transmit 2CW. Thus, after bundling HARQ response signals with respect to deactivate CCs, additional bundling is performed on the HARQ ACK/NACK signals of the SCC3 and ordering is performed in order different from that of the case of FIG. 15, according to the bundling order.

<Ordering Scheme 2—Evenly Distributing Bundled Signals to Two RM Coders>

As for bundling, HARQ response signals with respect to a deactivated CC are first bundled, and when additional bundling is required, it is performed according to any one of the foregoing predetermined references (1) to (3). In order to even distribute the bundled HARQ response signals to two RM coders, ordering may be performed along the frequency axis, ordering may be performed by applying interleaving, or ordering may be performed by grouping downlink subframes.

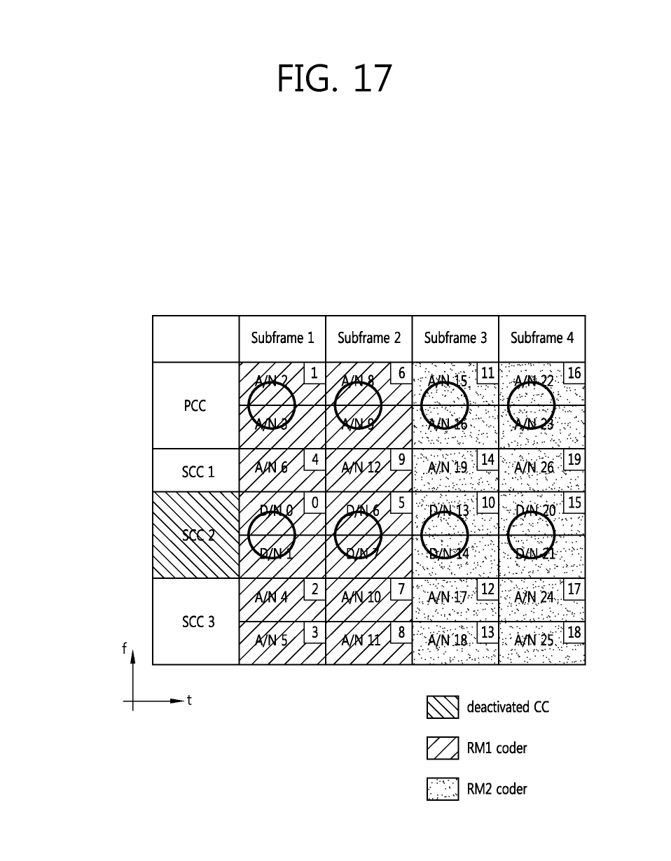

FIG. 17 illustrates a case in which ordering is performed along a frequency axis and additional ordering is performed according to the reference (1).

Referring to FIG. 17, first, bundling is performed on HARQ response signals corresponding to the deactivate CC SCC2. Additional bundling is performed on HARQ ACK/NACK signals corresponding to the PCC.

Subsequently, ordering is performed along the frequency axis of FIG. 17. Ordering is performed along the time axis of FIG. 17 such that, with respect to the subframe 1, the bundled HARQ response signals with respect to the SCC2 and the bundled HARQ ACK/NACK signals with respect to the PCC are input to the first RM coder.

Subsequently, unbundled HARQ ACK/NACK signals with respect to CCs are ordered. As for ordering order of SCC1 and SCC3 in which corresponding HARQ ACK/NACK signals are not bundling targets, the HARQ ACK/NACK signals with respect to the SCC3 in which 2CW transmission is scheduled may be first ordered although it has not been bundled, in order to perform ordering according to bundling order, or, simply, HARQ ACK/NACK signals with respect to the SCC1 may be first bundled in consideration of ascending order with respect to indices of CCs.

When ordering with respect to the subframe 1 is finished, HARQ response signals to be input to the first RM coder are ordered along the frequency axis of FIG. 17 with respect to the subframe 2. When the ordering of the HARQ ACK/NACK signals to be input to the first RM coder is finished, HARQ response signals to be input to the second RM coder are ordered along the frequency axis of FIG. 17 with respect to the subframes 3 and 4.

Referring to FIG. 17, it can be seen that the bundled HARQ response signals have been evenly distributed to the two RM coders.

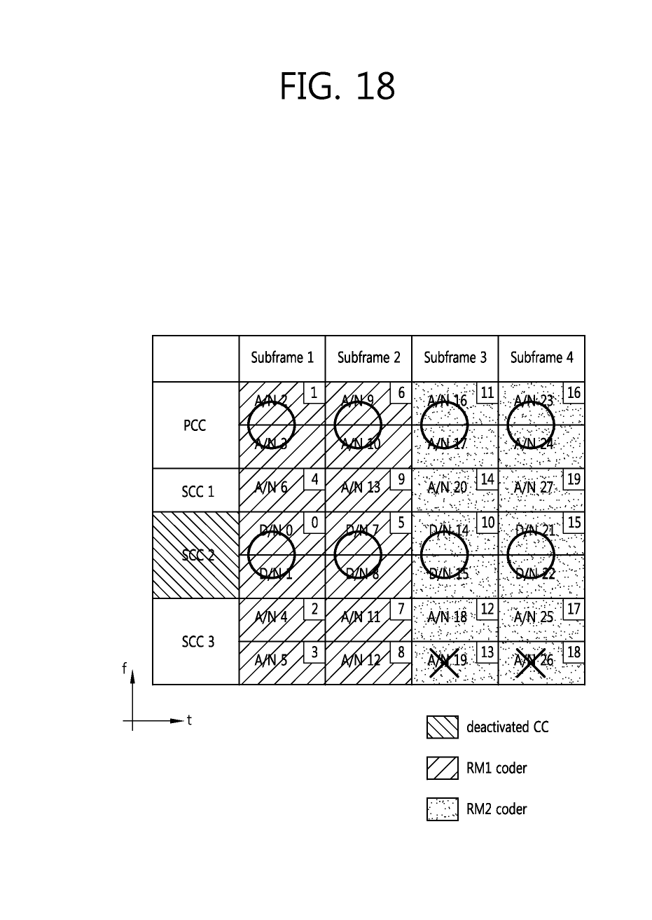

FIG. 18 illustrates an example in which ordering is performed along the frequency axis and additional ordering is performed according to the reference (2).

Referring to FIG. 18, unlike the case of FIG. 17, it can be seen that transmission of 2CW is more frequently made in the PCC actually, among the PCC and the SCC3 that may be able to transmit 2CW. Thus, after bundling HARQ response signals with respect to deactivate CCs, additional bundling is performed on the HARQ ACK/NACK signals of the PCC and ordering is performed along the frequency axis of FIG. 18 in consideration of the bundling order as described above.

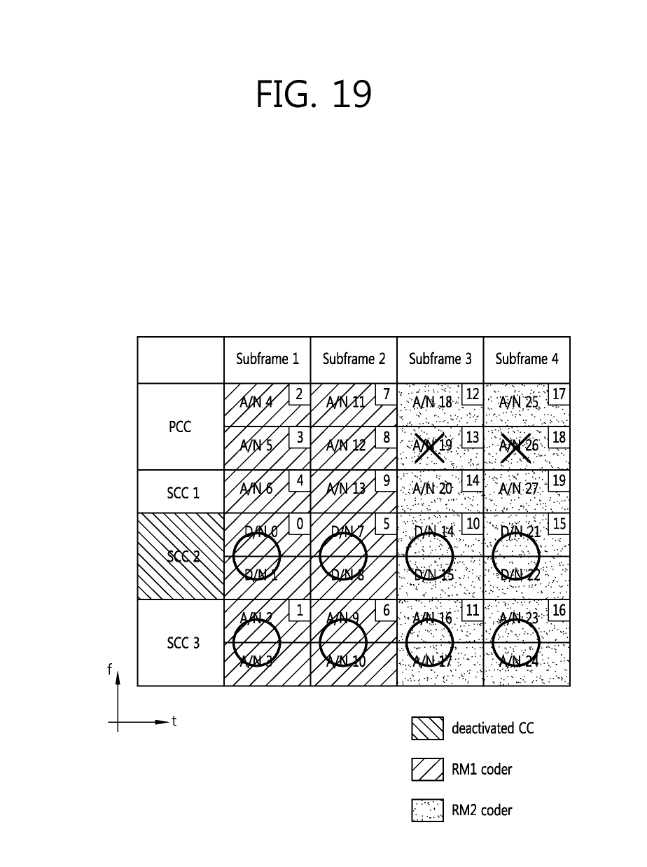

FIG. 19 illustrates another example in which ordering is performed along the frequency axis and additional ordering is performed according to the reference (2).

Referring to FIG. 19, unlike the case of FIG. 18, it can be seen that transmission of 2CW is more frequently made in the SCC3 actually, among the PCC and the SCC3 that may be able to transmit 2CW. Thus, after bundling HARQ response signals with respect to deactivate CCs, additional bundling is performed on the HARQ ACK/NACK signals of the SCC3 and ordering is performed in order different from that of the case of FIG. 18, in consideration of the bundling order.

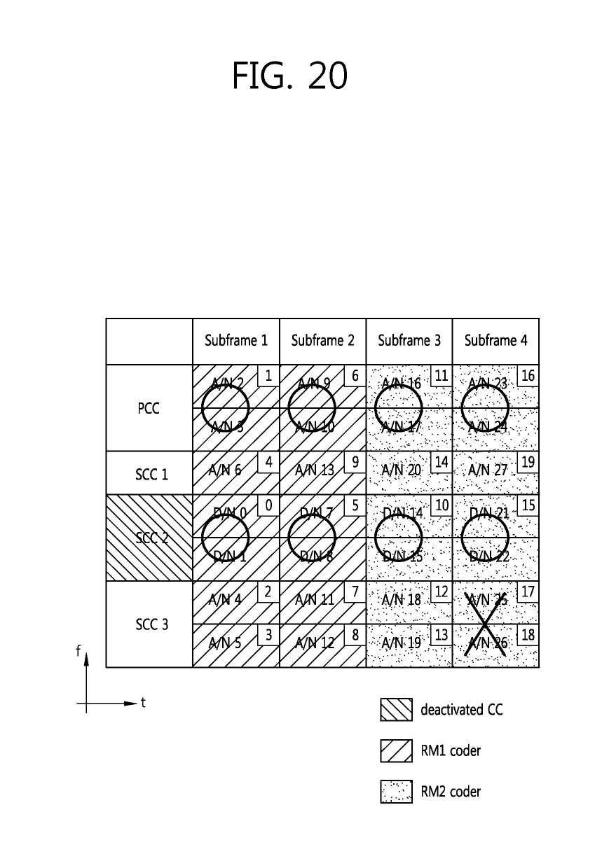

FIG. 20 illustrates an example in which ordering is performed along the frequency axis and additional ordering is performed according to the reference (3).

Referring to FIG. 20, it can be seen that transmission of 2CW is more frequently made in the PCC, among the PCC and the SCC3 that may be able to transmit 2CW. Thus, after bundling HARQ response signals with respect to deactivate CCs, additional bundling is performed on the HARQ ACK/NACK signals of the PCC and ordering is performed along the frequency axis in consideration of the bundling order as described above.

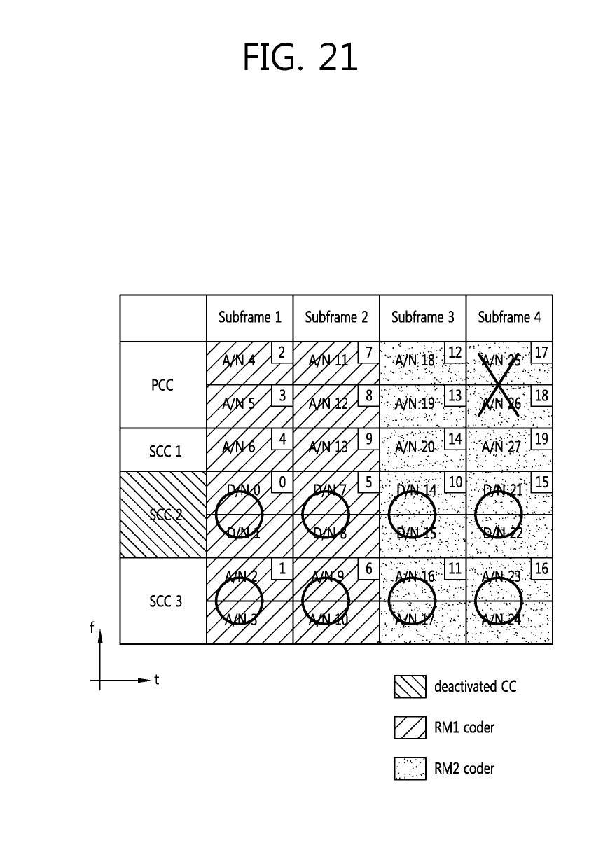

FIG. 21 illustrates another example in which ordering is performed along the frequency axis and additional ordering is performed according to the reference (3).

Referring to FIG. 21, unlike the case of FIG. 20, it can be seen that transmission of 2CW is more frequently made in the SCC3, among the PCC and the SCC3 that may be able to transmit 2CW. Thus, after bundling HARQ response signals with respect to deactivate CCs, additional bundling is performed on the HARQ ACK/NACK signals of the SCC3 and ordering is performed in order different from that of the case of FIG. 20, in consideration of the bundling order.

In the case of FIGS. 17 through 21, ordering is performed in consideration of the bundling order, but in order to evenly distribute bundled HARQ response signals to both RM corders, ordering may be performed in ascending order of the indices of PCC to SCC or in reverse order.

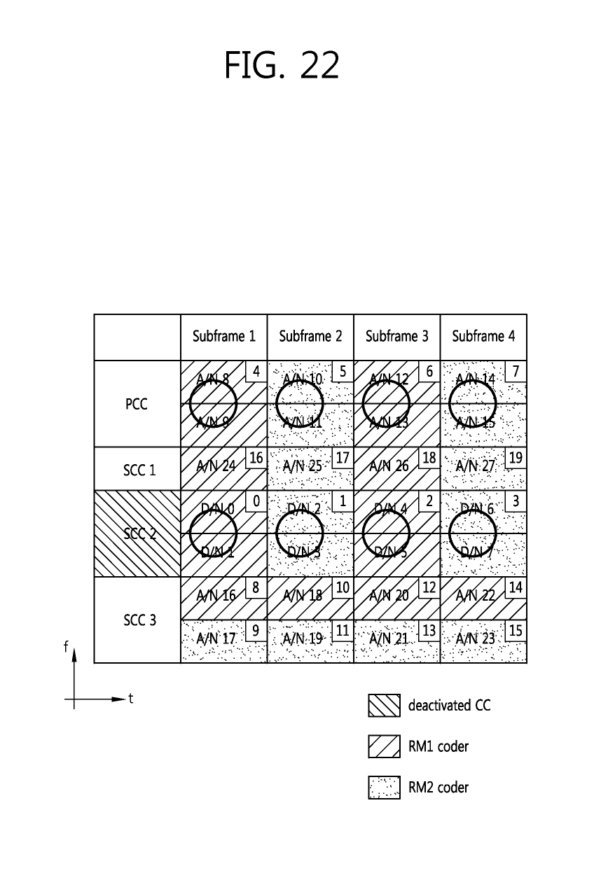

FIG. 22 is a view illustrating a case in which ordering is performed along a time axis by applying interleaving, and additional ordering is performed according to the reference (1).

Referring to FIG. 22, bundling is first performed on HARQ response signals corresponding to SCC2 as a deactivated CC. Additional bundling is performed on HARQ ACK/NACK signals corresponding to the PCC.

Subsequently, ordering may be performed along the time axis. Here, unlike the case of FIG. 12, in the case of FIG. 22, interleaving is applied, so ordering is performed such that HARQ response signals are cross-input to two RM coders.

Referring to FIG. 22, it can be seen that the bundled HARQ response signals are evenly distributed to the two RM coders.

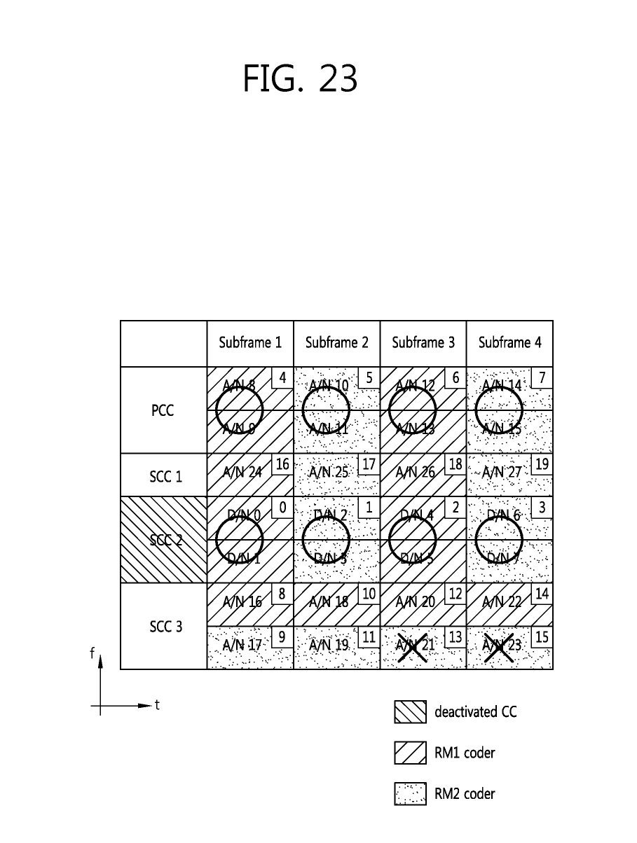

FIG. 23 is a view illustrating an example in which ordering is performed along a time axis by applying interleaving, and additional ordering is performed according to the reference (1).

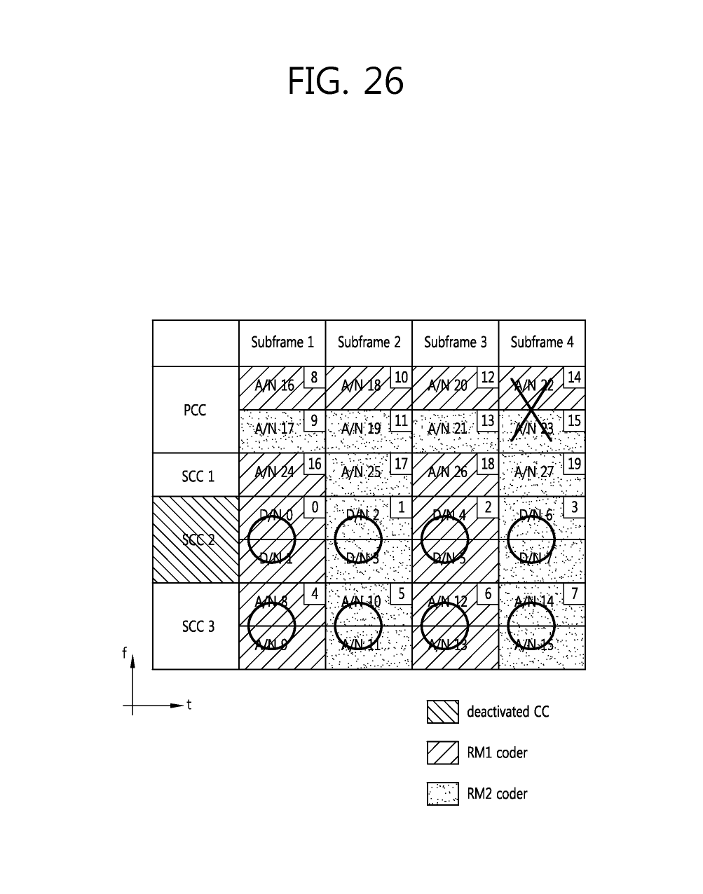

Referring to FIG. 23, unlike the case of FIG. 22, it can be seen that transmission of 2CW is more frequently made in the PCC actually, among the PCC and the SCC3 that may be able to transmit 2CW. Thus, after bundling HARQ response signals with respect to deactivate CCs, additional bundling is performed on the HARQ ACK/NACK signals of the PCC. Ordering is performed by applying interleaving along the time axis of FIG. 26 in consideration of the bundling order as described above.

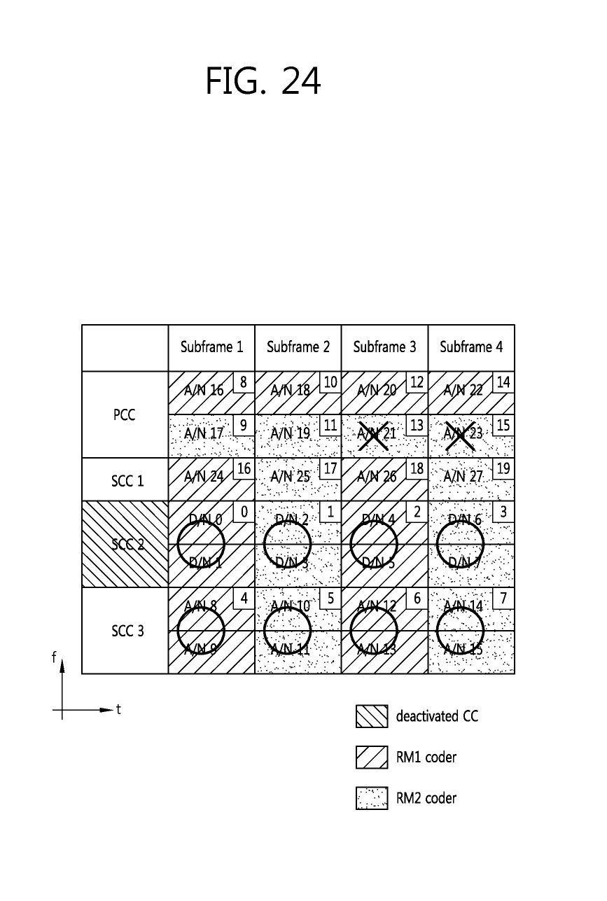

FIG. 24 illustrates another example in which ordering is performed by applying interleaving along the time axis and additional ordering is performed according to the reference (2).

Referring to FIG. 24, unlike the case of FIG. 23, it can be seen that transmission of 2CW is more frequently made in the SCC3 actually, among the PCC and the SCC3 that may be able to transmit 2CW. Thus, after bundling HARQ response signals with respect to deactivate CCs, additional bundling is performed on the HARQ ACK/NACK signals of the SCC3. Ordering is performed in order different from that of the case of FIG. 23, in consideration of the bundling order.

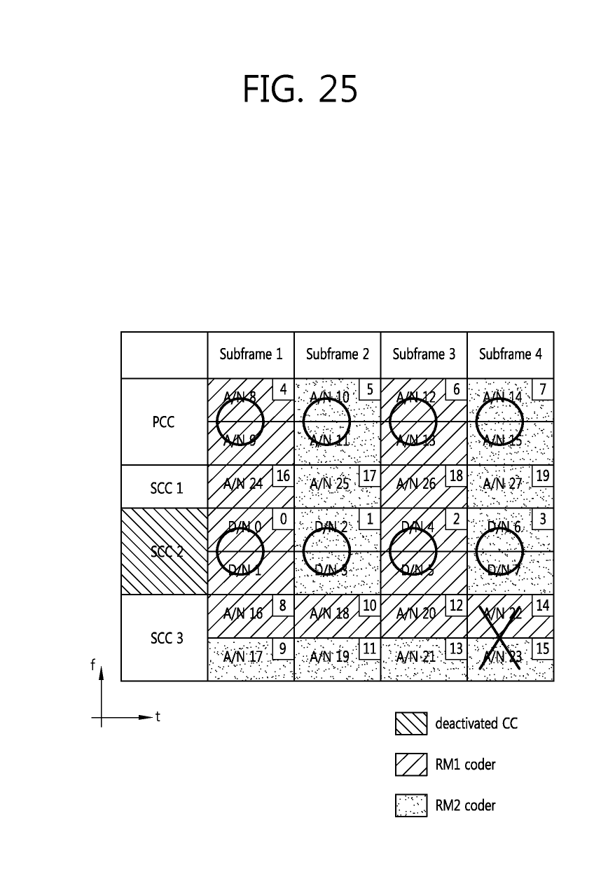

FIG. 25 illustrates another example in which ordering is performed by applying interleaving along the time axis and additional ordering is performed according to the reference (3).

Referring to FIG. 25, it can be seen that transmission of 2CW is more frequently made in the PCC, among the PCC and the SCC3 that may be able to transmit 2CW. Thus, after bundling HARQ response signals with respect to deactivate CCs, additional bundling is performed on the HARQ ACK/NACK signals of the PCC. Ordering is performed along the frequency axis of FIG. 25 by applying interleaving in consideration of the bundling order as described above.

FIG. 26 illustrates another example in which ordering is performed along the time axis by applying interleaving and additional ordering is performed according to the reference (3).

Referring to FIG. 26, unlike the case of FIG. 25, it can be seen that transmission of 2CW is more frequently made in the SCC3, among the PCC and the SCC3 that may be able to transmit 2CW. Thus, after bundling HARQ response signals with respect to deactivate CCs, additional bundling is performed on the HARQ ACK/NACK signals of the SCC3 and ordering is performed in order different from that of the case of FIG. 25, according to the bundling order.

In the case of FIGS. 22 through 26, ordering is performed in consideration of the bundling order, but ordering may be performed by interleaving them in ascending order of the indices of PCC to SCC or in reverse order along the time axis.

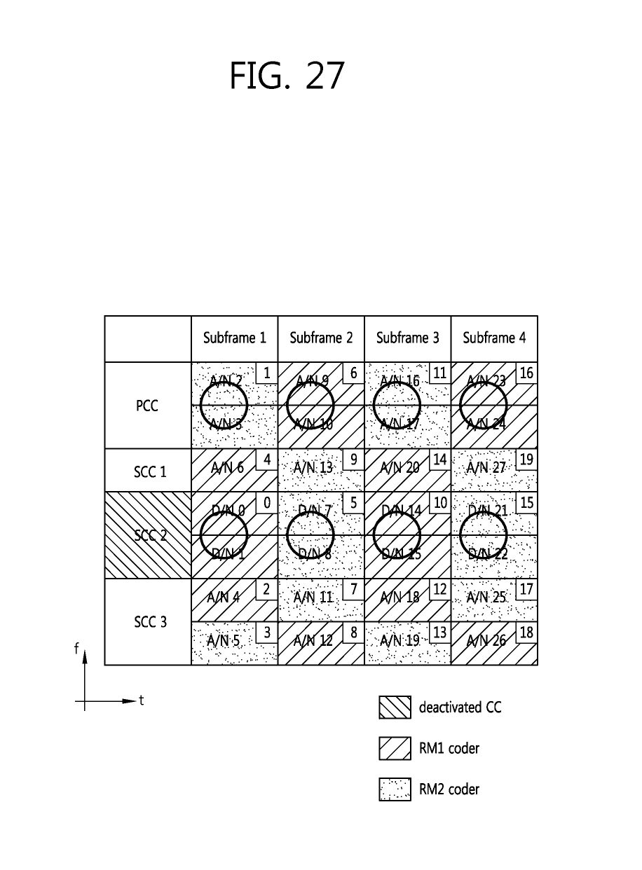

FIG. 27 illustrates a case in which ordering is performed along a frequency axis by applying interleaving and additional ordering is performed according to the reference (1).

Referring to FIG. 27, first, bundling is performed on HARQ response signals corresponding to the deactivate CC SCC2. Additional bundling is performed on HARQ ACK/NACK signals corresponding to the PCC.

Subsequently, ordering is performed along the frequency axis of FIG. 27. Here, unlike the case of FIG. 17, in the case of FIG. 27, interleaving is applied, so ordering is performed such that HARQ response signals are cross-input to two RM coders along the frequency axis of FIG. 27.

Referring to FIG. 27, it can be seen that the bundled HARQ response signals have been evenly distributed to the two RM coders.

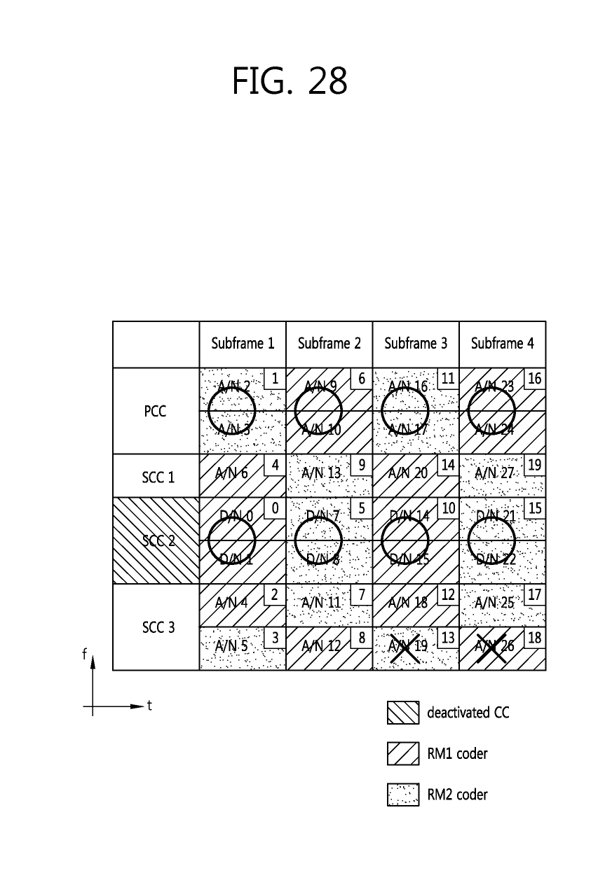

FIG. 28 illustrates an example in which ordering is performed along the frequency axis by applying interleaving and additional ordering is performed according to the reference (2).

Referring to FIG. 28, unlike the case of FIG. 27, it can be seen that transmission of 2CW is more frequently made in the PCC actually, among the PCC and the SCC3 that may be able to transmit 2CW. Thus, after bundling HARQ response signals with respect to deactivate CCs, additional bundling is performed on the HARQ ACK/NACK signals of the PCC. Ordering is performed by applying interleaving along the frequency axis of FIG. 28 in consideration of the bundling order as described above.

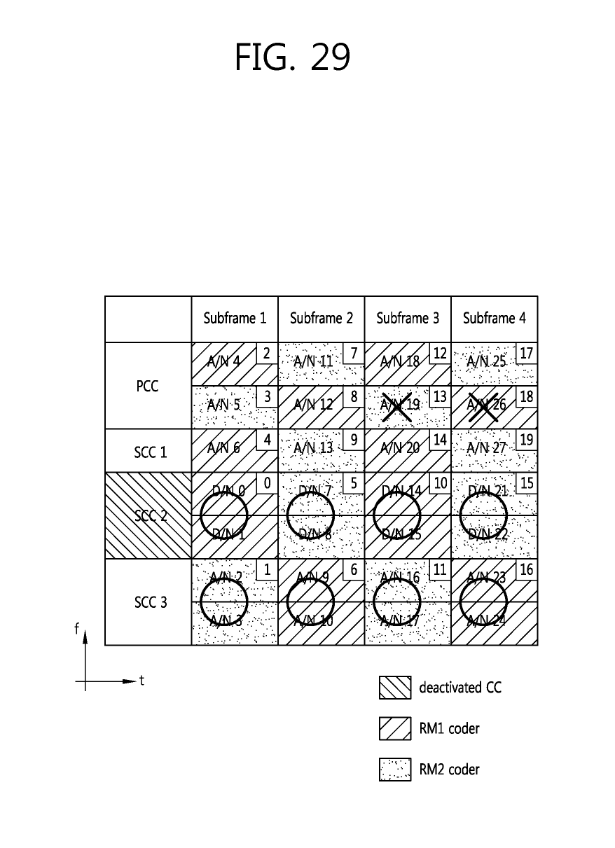

FIG. 29 illustrates another example in which ordering is performed along the frequency axis by applying interleaving and additional ordering is performed according to the reference (2).

Referring to FIG. 29, unlike the case of FIG. 28, it can be seen that transmission of 2CW is more frequently made in the SCC3 actually, among the PCC and the SCC3 that may be able to transmit 2CW. Thus, after bundling HARQ response signals with respect to deactivate CCs, additional bundling is performed on the HARQ ACK/NACK signals of the SCC3. Ordering is performed in order different from that of the case of FIG. 28, in consideration of the bundling order.

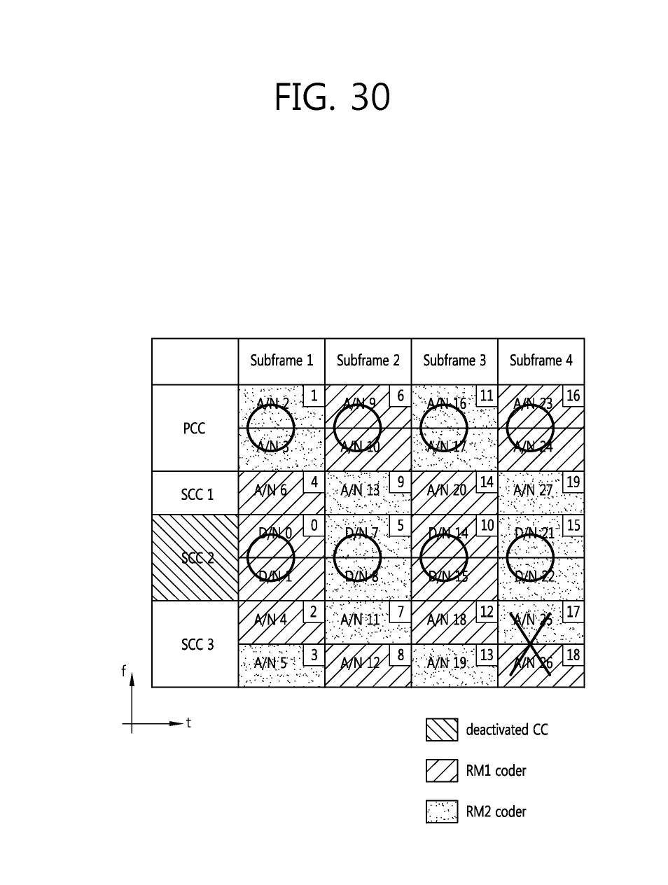

FIG. 30 illustrates an example in which ordering is performed along the frequency axis by applying interleaving and additional ordering is performed according to the reference (3).

Referring to FIG. 30, it can be seen that transmission of 2CW is more frequently made in the PCC, among the PCC and the SCC3 that may be able to transmit 2CW. Thus, after bundling HARQ response signals with respect to deactivate CCs, additional bundling is performed on the HARQ ACK/NACK signals of the PCC. Ordering is performed along the frequency axis of FIG. 30 by applying interleaving in consideration of the bundling order as described above.

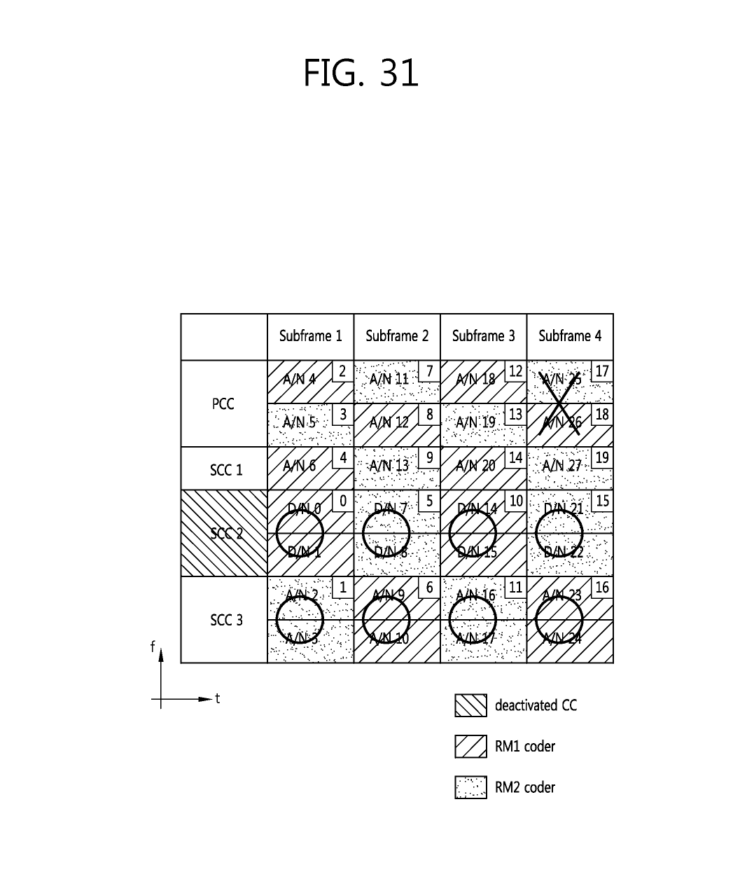

FIG. 31 illustrates another example in which ordering is performed along the frequency axis by applying interleaving and additional ordering is performed according to the reference (3).

Referring to FIG. 31, unlike the case of FIG. 30, it can be seen that transmission of 2CW is more frequently made in the SCC3, among the PCC and the SCC3 that may be able to transmit 2CW. Thus, after bundling HARQ response signals with respect to deactivate CCs, additional bundling is performed on the HARQ ACK/NACK signals of the SCC3 and ordering is performed in order different from that of the case of FIG. 30, in consideration of the bundling order.

In the case of FIGS. 27 through 31, ordering is performed in consideration of the bundling order, but ordering may be performed by interleaving them in ascending order of the indices of PCC to SCC or in reverse order.

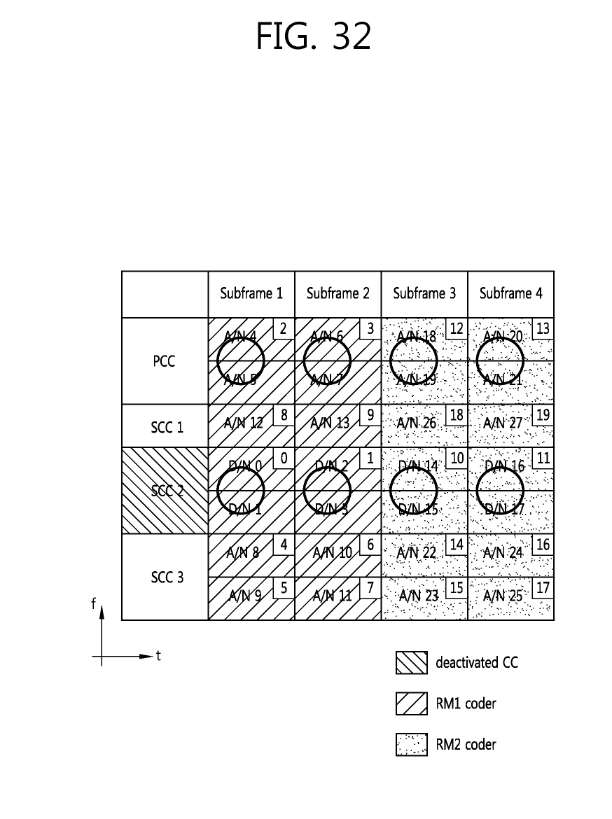

FIG. 32 is a view illustrating a case in which ordering is performed by grouping downlink subframes associated with an uplink subframe for transmitting HARQ response signals, and additional ordering is performed according to the reference (1).

Referring to FIG. 32, bundling is first performed on HARQ response signals corresponding to SCC2 as a deactivated CC. Additional bundling is performed on HARQ ACK/NACK signals corresponding to the PCC.

Subsequently, the subframes of FIG. 32 are grouped such that the bundled HARQ response signals input to the two RM coders may be evenly distributed. In FIG. 32, a case in which two first received subframes (subframe 1 and subframe 2) and the two subsequently received subframes (subframe 3 and subframe 4) are grouped is described as an example.

In each group, bundled HARQ response signals are first ordered, HARQ ACK/NACK signals with respect to CCs that transmit 2CW are ordered, and HARQ ACK/NACK signals with respect to CCs that transmit 1CW are ordered. Here, in consideration of the bundling order, the bundled HARQ response signals are first ordered and, in case of unbundled HARQ response signals, HARQ response signals with respect to CCs that transmit 2W are first bundled, but the present invention is not limited thereto and performing ordering in a direction from the PCC to the SCC having a higher index or in the opposite direction along the time axis or the frequency axis may also be considered.

Referring to FIG. 32, it can be seen that the bundled HARQ response signals are evenly distributed to the two RM coders.

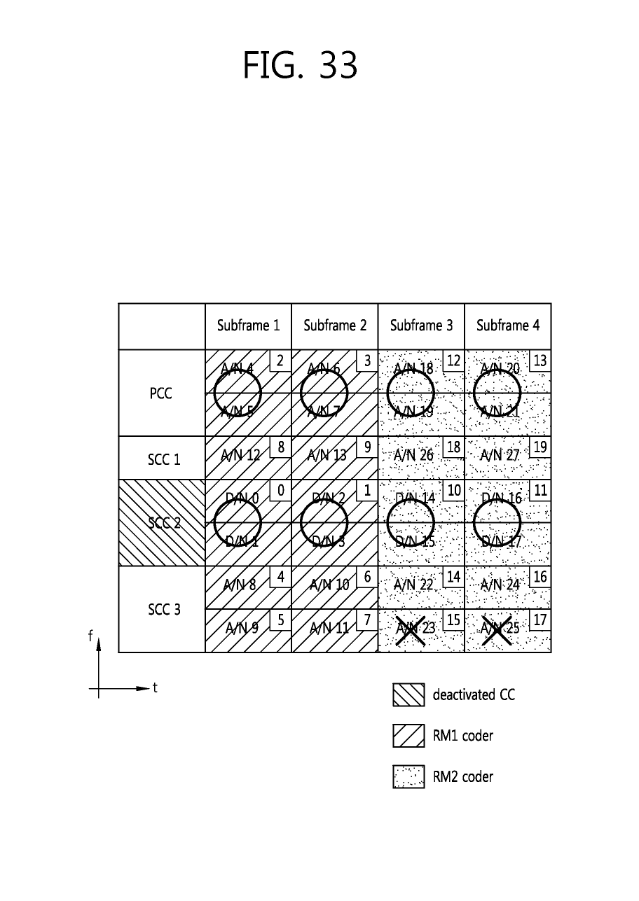

FIG. 33 is a view illustrating an example in which ordering is performed by grouping downlink subframes associated with an uplink subframe for transmitting HARQ response signals, and additional ordering is performed according to the reference (2).

Referring to FIG. 33, it can be seen that transmission of 2CW is more frequently made in the PCC actually, among the PCC and the SCC3 that may be able to transmit 2CW. Thus, after bundling HARQ response signals with respect to deactivate CCs, additional bundling is performed on the HARQ ACK/NACK signals of the PCC. Ordering is performed in consideration of the bundling order as described above.

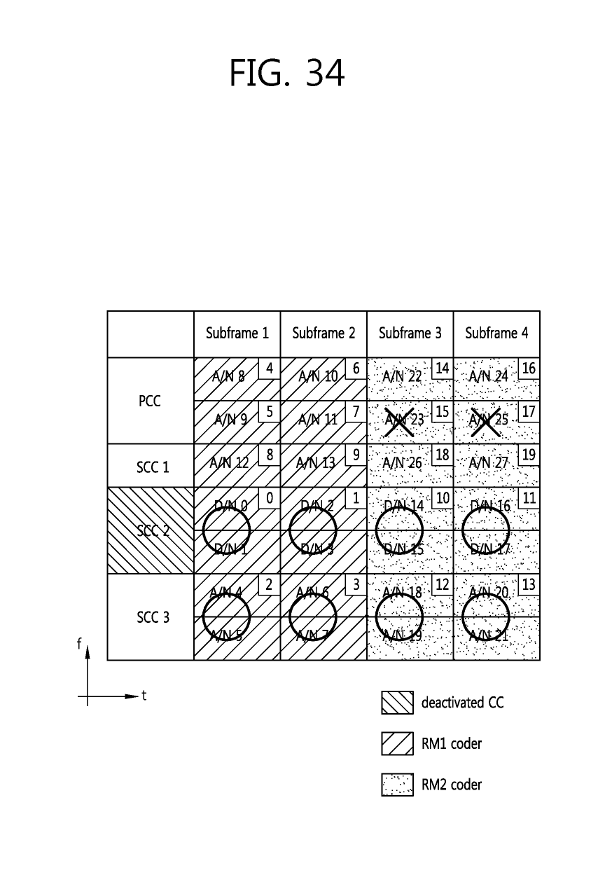

FIG. 34 is a view illustrating another example in which ordering is performed by grouping downlink subframes associated with an uplink subframe for transmitting HARQ response signals, and additional ordering is performed according to the reference (2).

Referring to FIG. 34, unlike the case of FIG. 33, it can be seen that transmission of 2CW is more frequently made in the SCC3 actually, among the PCC and the SCC3 that may be able to transmit 2CW. Thus, after bundling HARQ response signals with respect to deactivate CCs, additional bundling is performed on the HARQ ACK/NACK signals of the SCC3. Ordering is performed in order different from that of the case of FIG. 33, according to the bundling order.

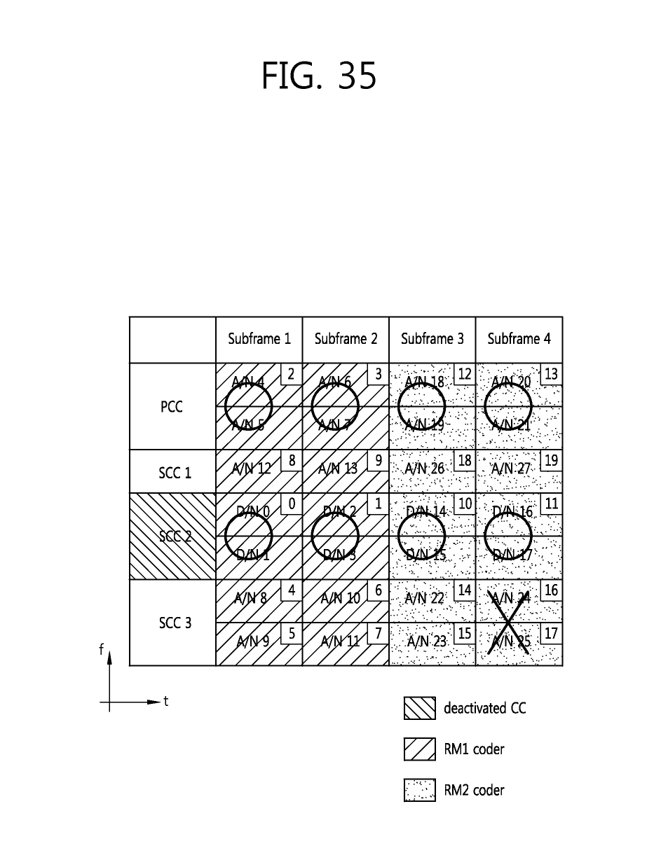

FIG. 35 is a view illustrating an example in which ordering is performed by grouping downlink subframes associated with an uplink subframe for transmitting HARQ response signals, and additional ordering is performed according to the reference (3).

Referring to FIG. 35, it can be seen that transmission of 2CW is more frequently made in the PCC, among the PCC and the SCC3 that may be able to transmit 2CW. Thus, after bundling HARQ response signals with respect to deactivate CCs, additional bundling is performed on the HARQ ACK/NACK signals of the PCC. Ordering is performed in consideration of the bundling order as described above.

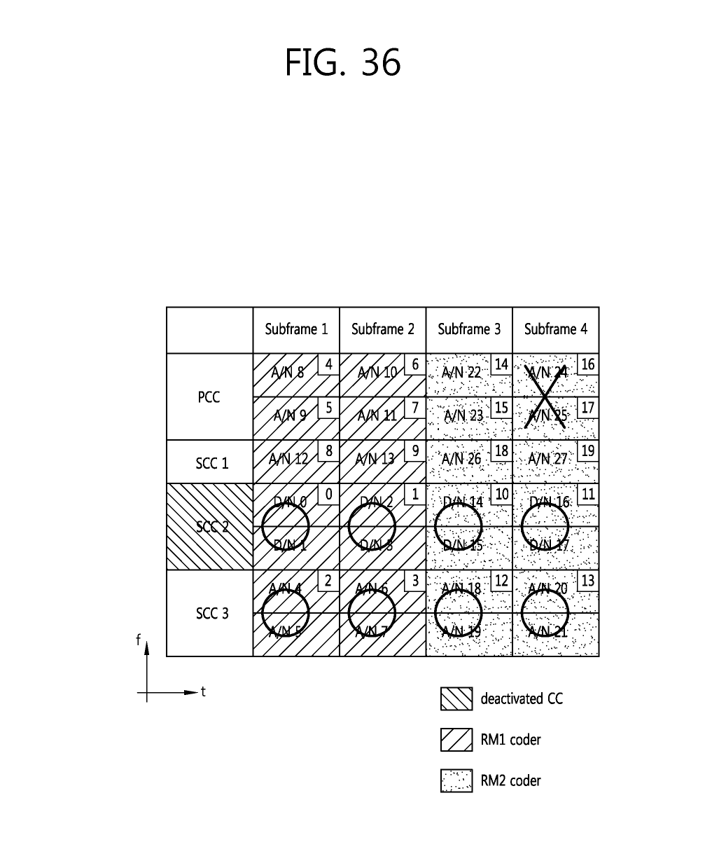

FIG. 36 is a view illustrating another example in which ordering is performed by grouping downlink subframes associated with an uplink subframe for transmitting HARQ response signals, and additional ordering is performed according to the reference (3).

Referring to FIG. 36, unlike the case of FIG. 35, it can be seen that transmission of 2CW is more frequently made in the SCC3, among the PCC and the SCC3 that may be able to transmit 2CW. Thus, after bundling HARQ response signals with respect to deactivate CCs, additional bundling is performed on the HARQ ACK/NACK signals of the SCC3 and ordering is performed in order different from that of the case of FIG. 35, according to the bundling order.

In the case of FIGS. 32 through 36, ordering is performed in consideration of the bundling order, but performing ordering in a direction from the PCC to the SCC having a higher index or in the opposite direction along the time axis or the frequency axis may also be considered.

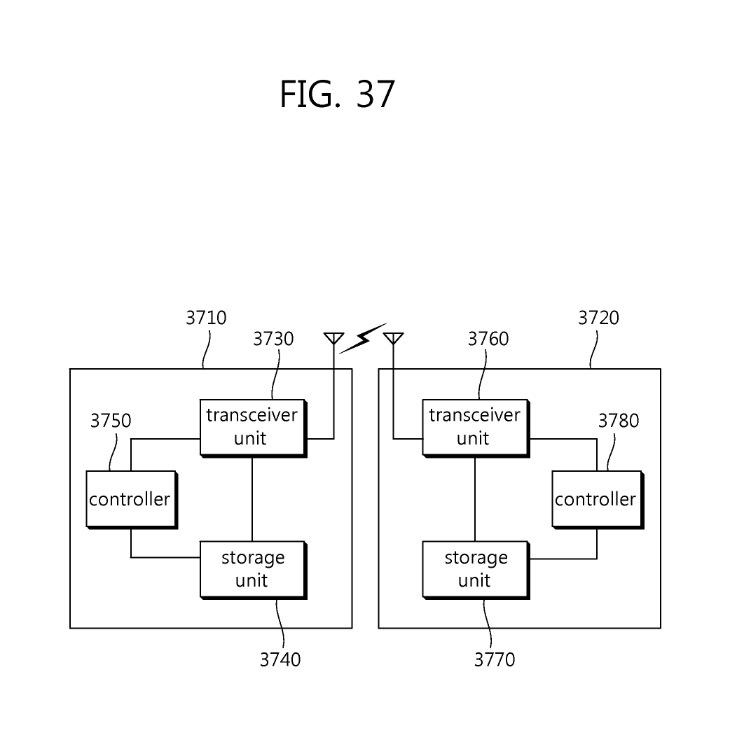

FIG. 37 is a block diagram illustrating an example of configurations of a BS and a UE in the system to which the present invention is applied.

A UE 3710 may include a transceiver unit 3730, a storage unit 3740, and a controller 3750. A BS 3720 may include a transceiver unit 3760, a storage unit 3770, and a controller 3780.

The UE 3710 transmits and receives required information via the transceiver unit 3730. For example, the UE may receive information regarding configuration of an HARQ response signal transmitted from the BS 3720, e.g., information regarding a PUCCH format, information/instruction regarding a bundling method and/or ordering method of HARQ response signals, and the like, via the transceiver unit 3730.

The storage unit 3740 may store required information to allow the UE 3710 to perform wireless communication in a network. The storage unit 3740 may store the information regarding configuration of an HARQ response signal, e.g., information regarding a PUCCH format, information/instruction regarding a bundling method and/or ordering method of HARQ response signals, and the like. Also, the storage unit 3740 may measure measurement information, e.g., CQI, RSRP, RSRQ, or the like, to be reported to the BS and store the same.

The controller 3750 may be connected to the transceiver unit 3750 and the storage unit 3740 to control them. Referring to FIGS. 1 and 2, the controller 3750 may include the bundling unit, the ordering unit, the segmentation unit, the dual-RM coding units, the DFT unit, and the IFFT unit. When transmitting HARQ response signals through the PUCH format 3 on the basis of information regarding configuration of an HARQ response signal, e.g., information regarding a PUCCH format, information/instruction regarding a bundling method and/or ordering method of HARQ response signals, and the like, stored in the storage unit 3740, the controller 3750 may perform bundling on HARQ response signals exceeding 20 bits and perform ordering on the HARQ response signals for RM coding and a follow-up process in consideration of bundling. The controller 3750 may channel-code the ordered HARQ response signals, perform DFT/IFFT processing thereon, and transmit the same via the transceiver unit 3730.

The BS 3720 may transmit and receive required information via the transceiver unit 3760. For example, the BS 3720 may transmit information/instruction required for configuring an HARQ response signal to be performed by the UE 3710 via the transceiver unit 3760.

The storage unit 3770 may store required information allowing the UE 3720 to perform wireless communication in a network. The storage unit 3770 may store information required for configuring an HARQ response signal performed by the UE, e.g., information required for bundling and ordering HARQ response signals. Also, the storage unit 3770 may store measure measurement information, e.g., CQI, RSRP, RSRQ, or the like, transmitted from the UE.

The controller 3780 may be connected to the transceiver unit 3760 and the storage unit 3770 to control them. The controller 3780 may determine a payload size of HARQ response signals in consideration of a number of downlink subframes associated with one uplink subframe, a number of component carriers configured in the downlink subframes associated with the one uplink subframe, a transmission mode of each CC (whether to transmit 1CW or 2CW by one CC in one downlink subframe), uplink grant, a scheme of spatial bundling to be used (whether to apply full bundling or whether to apply partial bundling), and the like.

Also, the controller 3780 may determine a bundling method in consideration of a determined payload size of HARQ response signals, a CQI, RSRP/RSRQ, and the like, transmitted from the UE, and may determine an ordering method of HARQ ACK/NACK signals to be performed by the UE in consideration of bundling. The controller 3780 may transfer information regarding the determined method to the UE 3710 via the transceiver 3760. Also, the controller 3780 may recognize a scheme of configuring HARQ ACK/NACK signals transmitted from the UE 3710 and decode the HARQ ACK/NACK signals, on the basis of information/instruction transmitted to the UE.

In the exemplary system as described above, the methods are described based on the flow chart by sequential steps or blocks, but the present invention is not limited to the order of the steps, and a step may be performed in different order from another step as described above or simultaneously performed. It would be understood by a skilled person in the art that the steps are not exclusive, a different step may be included, or one or more of the steps of the flow chart may be deleted without affecting the scope of the present invention.

While the present invention has been shown and described in connection with the embodiments, it will be apparent to those skilled in the art that modifications and variations can be made without departing from the spirit and scope of the invention as defined by the appended claims. Thus, the present invention is not limited to the foregoing embodiments and may include all the embodiments within the scope of the appended claims.

1. A method for processing HARQ ACK/NACK (Hybrid Automatic Repeat reQuest ACKnowledge/Non-ACK) signals of a user equipment (UE) that transmits HARQ ACK/NACK signals through a Physical Uplink Control Channel (PUCCH) format 3 in a TDD (Time Division Duplex) environment, the method comprising:
bundling predetermined HARQ ACK/NACK signals among HARQ ACK/NACK signals;
ordering HARQ ACK/NACK signals including the bundled HARQ ACK/NACK signals;
segmenting the ordered HARQ ACK/NACK signals; and
performing channel-coding on the segmented HARQ ACK/NACK signals according to the ordered sequence,
wherein the channel coding is performed by dual-coders, and the segmented HARQ ACK/NACK signals are divided to be input to the dual-coders, respectively.

2. The method of claim 1, wherein in the ordering, the bundled HARQ ACK/NACK signals are ordered such that they are evenly distributed to the dual-coders, respectively.

3. The method of claim 2, wherein in the ordering, the bundled HARQ ACK/NACK signals are ordered such that they are first distributed to the dual-coders before unbundled HARQ ACK/NACK signals.

4. The method of claim 2, wherein in the ordering, the bundled HARQ ACK/NACK signals are evenly distributed to each of the dual-coders sequentially one by one.

5. The method of claim 2, wherein in the ordering, unbundled HARQ ACK/NACK signals are interleaved and ordered.

6. The method of claim 1, wherein in the bundling, HARQ ACK/NACK signals with respect to deactivated component carriers (CCs) are first bundled.

7. The method of claim 6, wherein the bundling is performed until when the number of bits of the HARQ ACK/NACK signals reaches a predetermined number of bits, and
in a case in which the number of bits of the HARQ ACK/NACK signals is greater than the predetermined number of bits even after the HARQ ACK/NACK signals with respect to the deactivated CCs are bundled, HARQ ACK/NACK signals with respect to a primary component carrier (PCC) are bundled.

8. The method of claim 6, wherein the bundling is performed until when the number of bits of the HARQ ACK/NACK signals reaches a predetermined number of bits, and
in a case in which the number of bits of the HARQ ACK/NACK signals is greater than the predetermined number of bits even after the HARQ ACK/NACK signals with respect to the deactivated CCs are bundled, HARQ ACK/NACK signals with respect to a CC having a larger number of subframes that transmit a plurality of codewords among activated CCs are first bundled.

9. The method of claim 6, wherein the bundling is performed until when the number of bits of the HARQ ACK/NACK signals reaches a predetermined number of bits, and
in a case in which the number of bits of the HARQ ACK/NACK signals is greater than the predetermined number of bits even after the HARQ ACK/NACK signals with respect to the deactivated CCs are bundled, HARQ ACK/NACK signals with respect to a CC having a larger number of subframes among activated CCs that transmit a plurality of codewords are first bundled.

10. The method of claim 6, wherein in the ordering, after HARQ ACK/NACK signals segmented to be input to any one of the dual-coders are completely distributed, HARQ ACK/NACK signals to be segmented and input to the other coder are distributed, and
the segments of the bundled HARQ ACK/NACK signals are first distributed to one coder.

11. The method of claim 10, wherein in the ordering, among the segments of the bundled HARQ ACK/NACK signals, segments with respect to the deactivated CC are first distributed.

12. The method of claim 6, wherein in the ordering, the segments of the bundled HARQ ACK/NACK signals are evenly distributed to each coder constituting the dual-Reed Muller coders.

13. A user equipment (UE) to transmit an HARQ ACK/NACK (Hybrid Automatic Repeat request ACKnowledge/Non-ACK) signal, the UE comprising:
a bundling unit configured to bundle HARQ ACK/NACK signals;
an ordering unit configured to order HARQ ACK/NACK signals including the bundled HARQ ACK/NACK signals;
a segmentation unit configured to segment the ordered HARQ ACK/NACK signals; and
a coding unit configured to perform channel coding the segmented HARQ ACK/NACK signals according to the ordered sequence,
wherein the coding unit includes dual-coders,
the segmentation unit divides and inputs the segmented HARQ ACK/NACK signals to the dual-coders, and
the bundling unit performs bundling until when the number of the HARQ ACK/NACK signals reaches a predetermined number of bits.

14. The UE of claim 13, wherein the bundling unit performs bundling, starting from HARQ ACK/NACK signals with respect to deactivated component carriers (CCs).

15. The UE of claim 13, wherein the ordering unit distributes the segments of the bundled HARQ ACK/NACK signals such that they are concentratively input to one coder constituting the dual-Reed Muller coders or evenly distributes the segments of the bundled HARQ ACK/NACK signals to the two coders constituting the dual-Reed Muller coders.

16. A method for processing an HARQ ACK/NACK (Hybrid Automatic Repeat request ACKnowledge/Non-ACK) signal of a base station (BS), the method comprising:
determining a method for configuring and/or transmitting HARQ ACK/NACK signals;
transmitting information regarding the determined method for configuring and/or transmitting HARQ ACK/NACK signals to a user equipment (UE);
performing downlink data transmission; and receiving HARQ ACK/NACK signals with respect to the downlink data transmission from the UE,
wherein the information regarding the method for configuring and/or transmitting HARQ ACK/NACK signals includes at least any one of a payload size of the HARQ ACK/NACK signals to be transmitted by the UE, a bundling method to be performed by the UE, and an ordering method to be performed by the UE, and
the HARQ ACK/NACK signals transmitted from the UE are configured and/or transmitted on the basis of the information regarding the method for configuring and/or transmitting HARQ ACK/NACK signals.

17. The method of claim 16, wherein in the determining, the UE determines whether to perform bundling starting from HARQ ACK/NACK signals with respect to deactivated component carriers (CCs).

18. The method of claim 16, wherein in the determining, the UE determines to distribute the segments of the bundled HARQ ACK/NACK signals such that they are concentratively input to one coder constituting the dual-Reed Muller coders, or determine to distribute evenly the segments of the bundled HARQ ACK/NACK signals to the two coders constituting the dual-coders.

19. A base station (BS) device to receive HARQ ACK/NACK (Hybrid Automatic Repeat reQuest ACKnowledge/Non-ACK) signals through a Physical Uplink Control Channel (PUCCH) format 3 in a TDD (Time Division Duplex) environment, the BS device comprising:
a controller configured to determine a method for configuring and/or transmitting HARQ ACK/NACK signals; and
an RF (Radio Frequency) unit configured to transmit information regarding the determined method for configuring and/or transmitting HARQ ACK/NACK signals to a user equipment (UE), and receive HARQ ACK/NACK signals with respect to downlink data transmission from the UE,
wherein the method for configuring and/or transmitting HARQ ACK/NACK signals includes at least any one of a payload size of the HARQ ACK/NACK signals to be transmitted by the UE, a bundling method to be performed by the UE, and an ordering method to performed by the UE, and
the HARQ ACK/NACK signals transmitted from the UE are configured and/or transmitted on the basis of the information regarding the method for configuring and/or transmitting HARQ ACK/NACK signals.
